(19) United States
(12) Patent Application Publication
(10) Pub. No.: US 2023/0421598 A1
(43) Pub. Date: Dec. 28, 2023

(54) EMULATION OF NETWORK TRAFFIC TO PREPARE A MONITORING SYSTEM FOR COUNTERACTING EFFECTS OF IMPROPER NETWORK TRAFFIC

(71) Applicant: Clarity Consulting Corporation, Spring, TX (US)

(72) Inventors: Brandon Rains, Niceville, FL (US); Paul Williams, Spring, TX (US)

(21) Appl. No.: 18/243,165

(22) Filed: Sep. 7, 2023

Related U.S. Application Data
(63) Continuation-in-part of application No. 18/206,003, filed on Jun. 5, 2023.
Application No. 18/206,003 is a continuation-in-part of application No. 18/206,008, filed on Jun. 5, 2023.
Application No. 18/206,003 is a continuation-in-part of application No. 17/106,060, filed on Nov. 27, 2020, now Pat. No. 11,711,382.
Application No. 18/206,008 is a continuation-in-part of application No. 17/106,060, filed on Nov. 27, 2020, now Pat. No. 11,711,382.
(60) Provisional application No. 63/445,663, filed on Feb. 14, 2023.
(60) Provisional application No. 63/445,654, filed on Feb. 14, 2023.

(51) Int. Cl. H04L 9/40; H04L 43/04

(52) U.S. Cl. CPC H04L 63/1433; H04L 43/04

(57) ABSTRACT

Disclosed is an emulation method and system for preparing a monitoring device to monitor a network. A system processor correlates a first set of transmissions through a network of a monitored system to a first set of responses of a first control routine logic executed within a first monitored device of the monitored system, wherein the monitored system controls an industrial process performed within an external system coupled to the monitored system. The system processor adjusts a first parameter influencing an execution speed of the first control routine logic within a first emulation of the first monitored device to cause a response timing of the first set of responses to match a timing between two transmissions of the first set of transmissions. The system processor uses at least the first emulation to prepare the monitoring device to monitor the network to detect improper network activity affecting the industrial process while the monitored system controls the industrial process.

### RELATED APPLICATION

This application is a continuation-in-part of U.S. patent application Ser. No. 18/206,003 filed Jun. 5, 2023 by Paul Williams, and is also a continuation-in-part of U.S. patent application Ser. No. 18/206,008 also filed Jun. 5, 2023 by Paul Williams; the disclosures of each of which are incorporated herein by reference for all purposes. In turn, each of U.S. patent application Ser. Nos. 18/206,003 and 18/206,008 is a continuation-in-part of U.S. patent application Ser. No. 17/106,060 entitled “METHOD AND SYSTEM OF DEDUCING STATE LOGIC DATA WITHIN A DISTRIBUTED NETWORK” filed Nov. 27, 2020 by Paul Williams (since issued as U.S. Pat. No. 11,711,382 on Jul. 25, 2023; the disclosure of which is incorporated herein by reference for all purposes.

Each of U.S. patent application Ser. Nos. 18/206,003 and 18/206,008 also claims the benefit of the priority date of each of U.S. Provisional Application 63/445,654 entitled “SYSTEM AND METHOD FOR COUNTERACTING EFFECTS OF CYBER SECURITY BREACH OR OTHER DISRUPTION IN NETWORK COMMUNICATIONS” filed Feb. 14, 2023 by Paul Williams; and also claims the benefit of the priority date of U.S. Provisional Application 63/445,663 entitled “SYSTEM AND METHOD FOR ENHANCING COMPUTER NETWORK RELIABILITY AND COUNTERACTING EFFECTS OF A CYBER SECURITY BREACH” filed Feb. 14, 2023 by Paul Williams; the disclosures of each of which are also incorporated herein by reference for all purposes.

U.S. patent application Ser. No. 17/106,060 also claims the benefit of the priority date of U.S. Provisional Application 62/941,576 entitled “METHOD AND SYSTEM OF DEDUCING STATE LOGIC DATA WITHIN A DISTRIBUTED NETWORK” filed Nov. 27, 2019 by Paul Williams; the disclosure of which is incorporated herein by reference for all purposes.

### BACKGROUND

### 1. Technical Field

The present disclosure relates to the field of cybersecurity, specifically the use of emulations of monitored devices to prepare monitoring devices for use in counteracting the effects of an ongoing cybersecurity breach or other disruption in communications among the monitored devices.

### 2. Description of the Related Art

It has become commonplace to employ computing devices to control industrial processes, including and not limited to, chemical processes, automated assembly lines, and the provision of various utilities, including electric power. Unfortunately, this has opened the door to a wide variety of communications failures that may affect the control of industrial processes, thereby creating a plethora of information technology and industrial process failure scenarios. This has also opened the door to cyber attacks affecting the control of industrial processes, thereby creating the relatively new concern that cybersecurity breaches of computing devices may additionally result in the compromising of industrial processes. Accordingly, a new form of malicious activity has been created in which cybersecurity breaches are committed for the very purpose of disrupting and/or otherwise compromising industrial processes. Thus, in numerous possible ways, there may be failures in the timing of communications, and/or failures in the correctness of contents of communications.

By way of example regarding failures in communication, a computer server in an information technology network may cease performing its normal functions with little or no warning due to a malfunctioning or an erroneously configured hardware or software component. Alternatively, and by way of another example, a cyber attack technique such as a distributed denial of service (DDOS) attack may be directed against networked computing devices that are involved in the control of industrial processes. Such attacks may so thoroughly inundate such computing devices with network traffic as to entirely prevent them from engaging in communications related to industrial processes such that necessary transmissions of operational commands are at least significantly delayed, or simply never occur.

As will be familiar to those skilled in the art, the timing of the transmission of a particular operational command from one device to another may be as important to the correct performance of an industrial process as whether such a transmission ever occurs, at all. The failure to transmit information and/or commands when expected, or the failure to transmit information and/or commands at all, may result in portions of an information technology network or industrial process being performed for too long a period of time, being commenced at too late a time, or not being performed at all. A whole host of failures may result, including and not limited to, expensive failures cascading throughout an information technology network in an organization or failures in the successful production of products or successful provision of services, damage to equipment used to produce products or provide services, creation of hazardous conditions where industrial processes are performed, injuries and/or fatalities among personnel involved in performing industrial processes, and/or reputational and/or financial damage to corporate entities and/or other entities associated with information technology network or industrial processes. Still further, where an industrial process is part of a chain of related industrial processes, such compromising of the performance of one industrial process may adversely affect the ability to perform one or more preceding industrial processes, and/or one or more subsequent industrial processes.

By way of an example regarding incorrect communications, a computing device involved in the control of an industrial process may be successfully compromised by malicious software such that it becomes remotely controllable for the purpose of disrupting that industrial process. It may be that such a compromised computing device is caused to cease issuing proper operational commands in a proper order with proper timings and/or parameters, and instead, it may be caused to issue improper operational commands that cause improper operation of robotic arms/actuators, conveyor motors, power relays, welding devices, valves, heating and/or cooling units, etc. Such devices may be caused to operate outside of equipment design limitations, and/or with incorrect timings that violate operational and/or safety requirements. Beyond simply impairing the correct performance of an industrial process, the results could include wasting raw materials, releasing and/or spilling hazardous materials, destroying sub-assemblies, damaging equipment and/or facilities, and/or placing personnel in physical danger.

The malicious operational commands that are so issued may be altered versions of proper operational commands such that the operational commands may actually be issued when they are expected to be issued, but may include incorrect parameters that specify one or more incorrect values, such as an incorrect device identifier, temperature, pressure, direction of movement, extent of movement, countdown time, upper or lower limit, etc. Alternatively or additionally, the malicious operational commands actually may be proper operational commands for the industrial processing being performed, but they may be issued at improper times and/or out of proper sequence. As still another alternative, it may simply be that entirely new malicious operational commands are issued without any connection to the content and/or timing of proper operational commands.

The use of cyber attack techniques in such attacks on industrial processes often begets the temptation to focus on using longstanding cybersecurity measures to counter them. Such longstanding cybersecurity measures include, and are not limited to, the use of various malicious code digital signatures to detect 1) the transmission, receipt and/or storage of particular sequences of executable instructions of malicious pieces of software, 2) the transmission of particular malicious combinations of operational commands across a network by a computing device, and/or 3) the performance of particular malicious combinations of actions by a computing device. Such approaches have been useful in attempting to prevent the infiltration and/or execution of malicious software, and/or halting further execution of malicious software. However, as will be familiar to those skilled in the art, such approaches often set up a form of “arms race” between developers of malicious software and developers of the signatures used in such detection.

Unavoidably, there is a delay between the deployment of new malicious software and/or other varieties of attacks, and the development of corresponding defensive measures (e.g., signatures) such that it is inevitable that at least some of such software and/or attacks will be successful in causing harm before being detected. As a result, such approaches usually do little to address the harm done to industrial processes in situations where malicious software or other unexpected and/or nefarious activity is not yet detected until after some amount of damage has been underway for at least some amount of time.

An additional issue is the disruption to the normal functioning of computing devices that is often caused by the introduction of various longstanding cybersecurity measures, including to the function of controlling an industrial or other process. Such measures usually entail the installation of new cyber security software on existing computing devices, thereby consuming resources of those devices. It is not unheard of for a computing device to require enhancements to processing and/or storage resources, or to require being replaced with another computing device having such enhancements in plate, to accommodate the consumption of resources by cyber security software. Indeed, as a result of such issues, it is not uncommon for the installation of cybersecurity software on computing devices to be regarded as a case where the proverbial cure is worse than the proverbial disease. Additionally, it is also not unheard of for the installation of cyber security software and/or the replacement of computing devices to cause changes in behavior in controlling a process. More specifically, there may be slight alterations to the timing and/or ordering of the transmission of operational commands and/or data that may seem innocuous, but which beget unforeseen deleterious results as a result of triggering an unforeseen and/or unknown quirk of the logic employed in controlling a process.

Further, such installations often require some degree of adjustment in distinguishing between undesired events arising from failures and/or cyber security attacks, and events that normally occur during normal functioning associated with controlling a process. Such adjustments to address missed conditions and/or false alarms can further compound disruptions, and may still further become another avenue by which unforeseen deleterious results are triggered.

The present invention addresses these and other drawbacks of the prior art by providing a unique approach to detecting and mitigating the effects of such events on computing devices and/or communications among computing devices involved in the performance of industrial processes and other repetitive loop processes. The present invention also address these and other drawbacks of the prior art by providing a unique approach to thoroughly preparing a monitoring system to perform such detection and mitigation prior to deployment.

### BRIEF SUMMARY

Techniques are described for providing a system of one or more devices that implements a method for counteracting the effects of an ongoing cybersecurity breach or other disruption on communications among devices.

In an illustrative emulation system, a system processor is configured to correlate a first set of transmissions through a network of a monitored system to a first set of responses of a first control routine logic executed within a first monitored device of the monitored system, wherein the monitored system controls an industrial process performed within an external system coupled to the monitored system. The system processor adjusts a first parameter influencing an execution speed of the first control routine logic within a first emulation of the first monitored device to cause a response timing of the first set of responses to match a timing between two transmissions of the first set of transmissions. The system processor uses at least the first emulation to prepare a monitoring device to monitor the network to detect improper network activity affecting the industrial process while the monitored system controls the industrial process.

In an illustrative method of preparing a monitoring device to monitor a network, a system processor correlates a first set of transmissions through a network of a monitored system to a first set of responses of a first control routine logic executed within a first monitored device of the monitored system, wherein the monitored system controls an industrial process performed within an external system coupled to the monitored system. The system processor adjusts a first parameter influencing an execution speed of the first control routine logic within a first emulation of the first monitored device to cause a response timing of the first set of responses to match a timing between two transmissions of the first set of transmissions. The system processor uses at least the first emulation to prepare the monitoring device to monitor the network to detect improper network activity affecting the industrial process while the monitored system controls the industrial process.

### BRIEF DESCRIPTION OF THE DRAWINGS

The disclosure will be better understood and when consideration is given to the drawings and the detailed description which follows. Such description makes reference to the annexed drawings wherein:

FIGS. 1A, 1B, 1C, 1D, 1E and 1F, together, provide block diagrams of an example embodiment of a combination of a monitored system to control an external system process, a monitoring system to monitor communications of the monitored system, and an emulation system to prepare the monitoring system.

FIGS. 2A, 2B and 2C, together, provide a more detailed presentation of monitoring of communications within the monitored system by the monitoring system in the example combination of FIGS. 1A-F.

FIGS. 3A, 3B and 3C, together, provide a more detailed presentation of interactions among the monitored system communications and logic, and the external system communications and state machine.

FIGS. 4A, 4B and 4C, together, provide a more detailed presentation of aspects of a gathering phase of preparing the monitoring system for use—data is gathered to serve as part of the basis for emulations of behaviors of the monitored system, the external system and/or of the process.

FIGS. 5A, 5B, 5C, 5D, 5E and 5F, together, provide a more detailed presentation of aspects of a pre-training phase of preparing the monitoring system for use—the gathered data is used to define behaviors and/or timings of the emulations.

FIGS. 6A and 6B, together, provide a more detailed presentation of aspects of a training phase of preparing the monitoring system for use—the emulations are used to train, test and/or demonstrate abilities of the monitoring system.

### DETAILED DESCRIPTION

In the following detailed description, reference is made to the accompanying drawings that form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Broadly speaking, emulations are generated of portions of a monitored system and/or of portions of a process controlled by the monitored system. Aspects of the emulations are based on at least a combination of samples of actual network traffic within the monitored system and information concerning logic that is employed by the monitored system to control the process. The emulations are then used to prepare one or more monitoring devices for use in monitoring the monitored system to at least detect improper network traffic that may arise due to malfunctions and/or cyber security breaches.

An emulation method and system for preparing a monitoring device to monitor a network includes a system processor that correlates a first set of transmissions through a network of a monitored system to a first set of responses of a first control routine logic executed within a first monitored device of the monitored system, wherein the monitored system controls an industrial process performed within an external system coupled to the monitored system. The system processor adjusts a first parameter influencing an execution speed of the first control routine logic within a first emulation of the first monitored device to cause a response timing of the first set of responses to match a timing between two transmissions of the first set of transmissions. The system processor uses at least the first emulation to prepare the monitoring device to monitor the network to detect improper network activity affecting the industrial process while the monitored system controls the industrial process.

### Overview of Systems and Interplay Among Systems

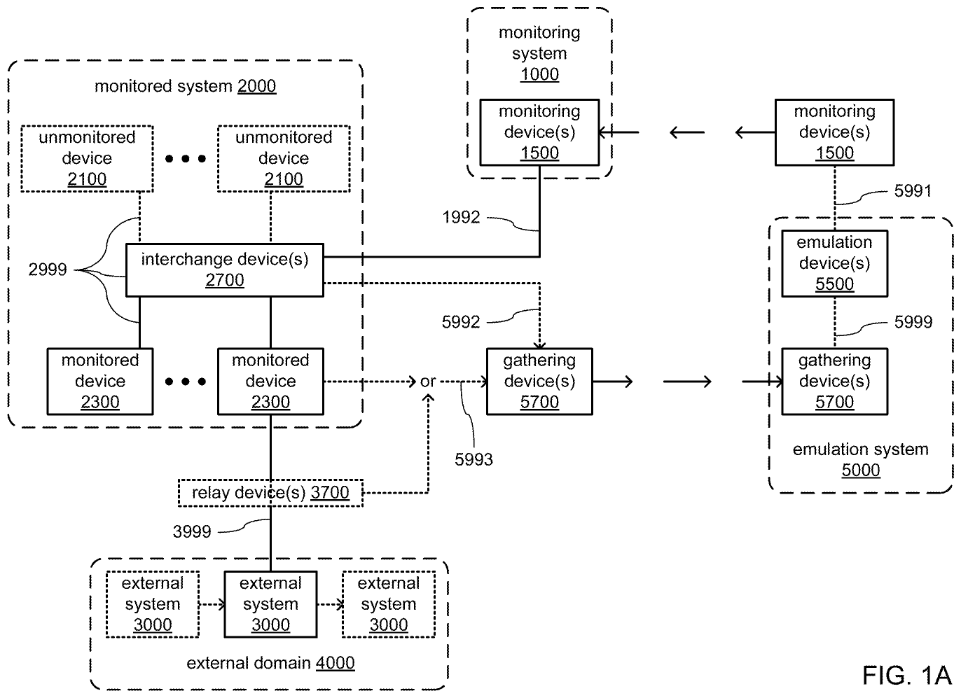

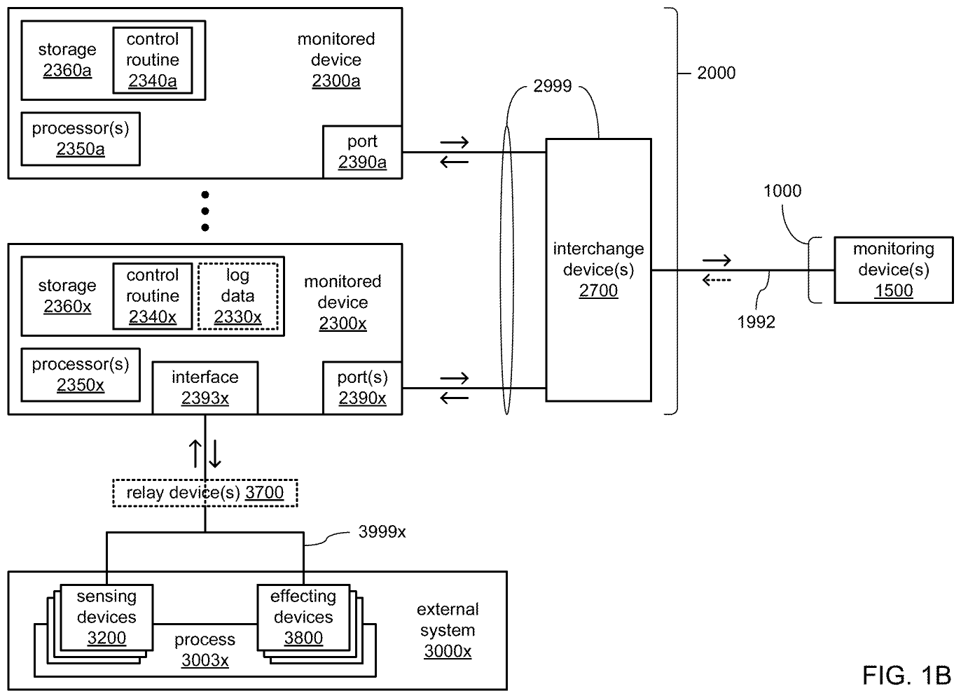

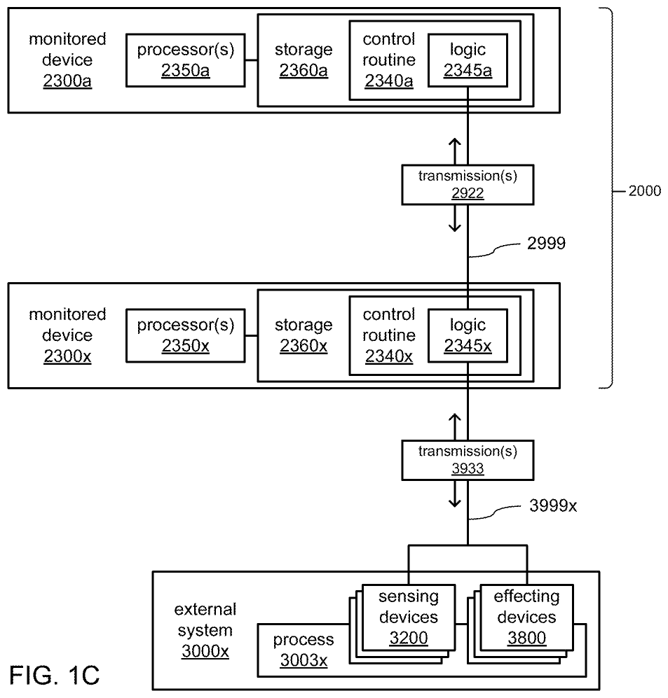

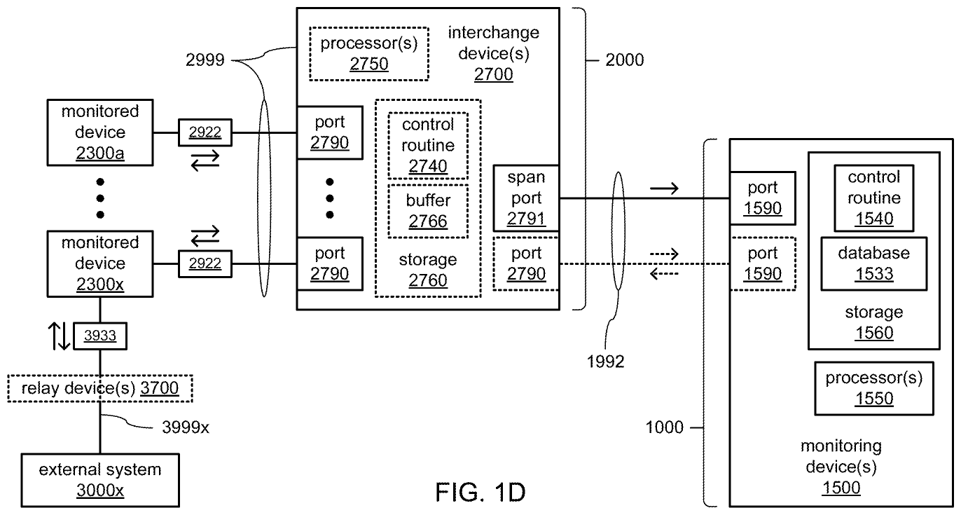

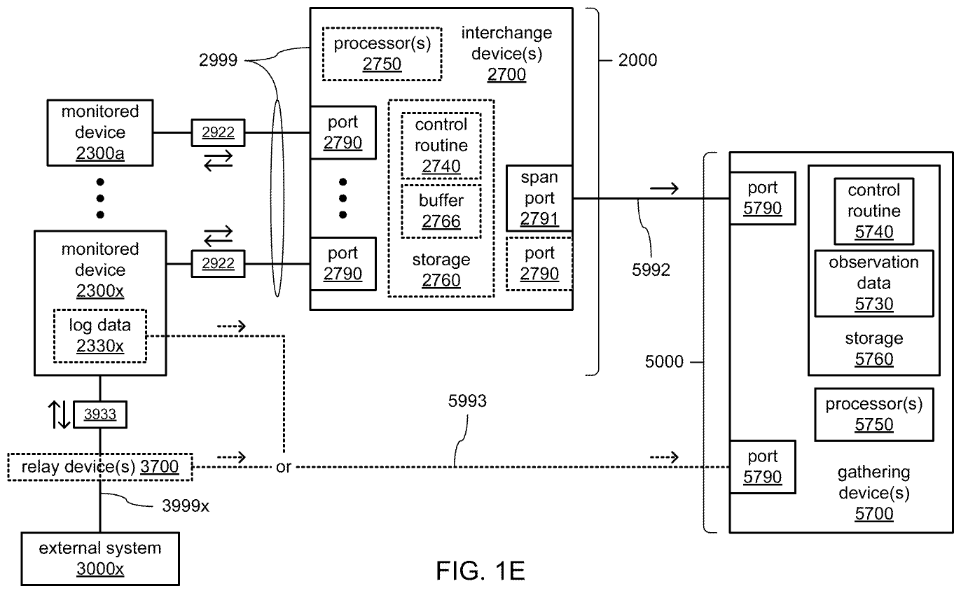

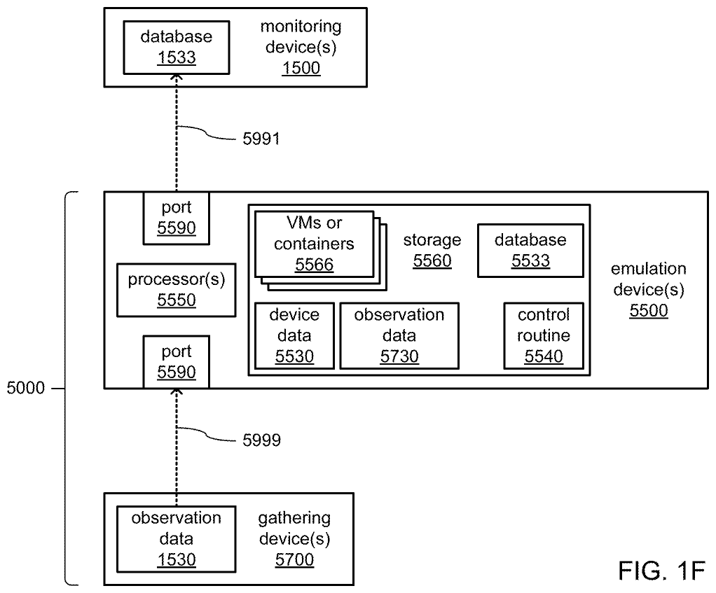

FIGS. 1A, 1B, 1C, 1D, 1E and 1F, taken together, present an example of a monitoring system 1000 being prepared, and then being deployed, to monitor transmissions of operational commands and/or operational information within a monitored system 2000 for purposes of a controlling aspects of an industrial or other type of process performed within an external system 3000. The particular external system 3000 that is so controlled may be one of multiple external systems 3000 that define an external domain 4000 by which products may be produced; utility services may be monitored, controlled and/or provided; etc. An emulation system 5000 that emulates behaviors of the monitored system 2000 and/or of the particular external system 3000 may be employed in training and/or testing the monitoring system 1000 as part of the monitoring system 1000 for its deployment. FIG. 1A introduces components of each of the systems 1000, 2000, 3000, 4000 and 5000; FIGS. 1B-D, together, depict aspects of using the monitoring system 1000 to monitor and/or correct communications traffic of the monitored system 2000 after being prepared for such use; and FIGS. 1E-F, together, depict aspects of preparing the monitoring system 1000 for such use.

Turning to FIG. 1A, in some embodiments, the monitored system 2000 may include a variety of computing devices interconnected by a communications network 2999. Among such computing devices may be multiple monitored devices 2300 that are involved in controlling the industrial process or other type of process that occurs within the one of the external systems 3000 that is depicted as being coupled to one of the monitored devices 2300. As part of being used together in a cooperative manner to control that process, various operational commands or information may be transmitted through the network 2999 among at least a subset of those monitored devices 2300.

For purposes of this patent application, it is important to note that the use of such terms as “monitoring” and “monitored” refer to the monitoring, by the monitoring system 1000, of communications through the network 2999 and among the monitored devices 2300 of the monitored system 2000 as part of providing reliability and/or cyber security services for the monitored system 2000. Thus, these terms do not refer to the use of the monitored system 2000 to control of any industrial process or other type of process performed within an external system 3000.

Also among the computing devices connected to the network 2999 may be one or more unmonitored devices 2100 where none of the communications therewith through the network 2999 are monitored by the monitoring system 1000. It may be that at least a subset of the unmonitored device(s) 2100 does engage in communications with at least a subset of the multiple monitored devices 2300 through the network 2999. However, it may also be that none of those communications are associated with controlling an industrial process or other type of process performed within one of the external systems 3000, and therefore, it may be deemed unnecessary to monitor those communications.

As depicted, the network 2999 may include one or more interchange devices 2700. Each such interchange device 2700 may be any of a variety of types of network device, including and not limited to, a router, network switch, wireless network access point, network bridge, etc. In the network 2999, it may be that each transmission of command(s) and/or information among devices coupled to the network 2999 is so transmitted through at least one interchange device 2700.

Also as part of controlling an external system 3000, and as depicted, at least one of the monitored devices 2300 may be coupled to that external system 3000 by one or more communications links 3999 to both monitor and control various aspects of a process that is performed with that external system 3000. Thus, in controlling such a process, there may be transmissions between such a monitored device 2300 and such an external system 3000 through the one or more links 3999, in addition to there being transmissions among multiple monitored devices 2300 through the network 2999. Depending on the particular technologies employed by the link(s) 3999, one or more relay devices 3700 may be incorporated into the one or more links 3999.

In view of their central role in conveying transmissions through the network 2999, it may be that monitoring transmissions of operational commands and/or operational information among the monitored devices 2300 entails monitoring network traffic passing through each of the one or more interchange devices 2700. To do so, at least one of the one or more interchange devices 2700 may be coupled to the monitoring system 1000 via a link 1992.

As depicted, the monitoring system 1000 may include one or more monitoring devices 1500, and each of the one or more monitoring devices 1500 may be still another computing device. It may be that the monitoring system 1000 is remotely located from the monitored system 2000 such that it may be deemed to be entirely separate therefrom. Alternatively, it may be that the monitoring system 1000 is co-located with at least a portion of the monitored system 2000, and/or is otherwise integrated with the monitored system 2000, such that it may be deemed to be included therein.

The preparation of the one or more monitoring devices 1500 for use in monitoring the monitored system 2000 may include three distinct phases. In a gathering phase, one or more gathering devices 5700 of the emulation system 5000 may be temporarily coupled to the interchange device(s) 2700 by one or more links 5992 to observe and capture communications activity occurring on the network 2999. Also, at least one gathering device 5700 may be additionally temporarily coupled to the relay device(s) 3700 and/or to at least one monitoring device 2300 by one or more links 5993 to observe and capture communications activity occurring on the link(s) 3999. In so doing, the gathering device(s) 5700 may generate observation data descriptive of the activity captured from at least the network 2999, if not also from the link(s) 3999.

Following the gathering phase, in a pre-training phase, the gathering device(s) 5700 may be uncoupled from the interchange device(s) 2700, the relay device(s) 3700 and/or the at least one monitored device 2300, and the observation data generated by the gathering device(s) 5700 may be provided to the one or more emulation devices 5500. In so providing the observation data to the emulation device(s) 5500, the gathering device(s) 5700 may be temporarily coupled thereto through one or more links of a network 5999. The emulation device(s) 5500 may be used to combine the observation data with other data concerning various aspects of the monitored device(s) 2300, the process that is being controlled, and/or the external system 3000 in which the process is performed, to generate and/or tune aspects of emulations of the monitored devices 2300, the external system 3000 and/or of the process that is being controlled.

Following the pre-training phase, in an emulation training phase, the emulation device(s) 5500 may be temporarily coupled to the monitoring device(s) 1500 through one or more links 5991 in a manner that is meant to mimic the manner in which the monitoring device(s) 1500 are to be coupled to the monitored system 2000 after the monitoring device(s) 1500 have been prepared for use. The emulation device(s) 5500 may then generate an emulation of behaviors of a combination of the monitored system 2000, the external system 3000 in which the process is performed and/or the process as part of providing the monitoring device(s) 1500 with an emulation of corresponding communications activity on the network 2999 for use in training and/or testing the monitoring device(s) 1500.

Following the preparation of the monitoring device(s) 1500 through the aforementioned three phases, the monitoring device(s) 1500 may be uncoupled from the emulation device(s) 5500, and then coupled to the one or more interchange device(s) 2700 of the monitored system 2000 via the one or more links 1992. The monitoring device(s) 1500 may then commence monitoring the communications activity through the network 2999 for instances of improper network traffic, and may respond to selected ones of such instances in various ways that will be described in greater detail.

As will be explained in greater detail, through such use of separate monitoring device(s) 1500 to detect anomalous network traffic on the network 2999, the effects of a cyber attack or a malfunction on the control of an industrial or other process is able to be mitigated. Also, this is able to be accomplished without consuming processing, storage and/or other resources of the monitored devices 2300, which might impair the control of the process. However, as those skilled in the art will readily recognize, such monitoring device(s) 1500 are not able to be effective if they are not used.

Thus, and as will also be explained in greater detail, through such use of emulation of such behaviors, the monitoring device(s) 1500 are able to be prepared for use in a manner that minimizes down time and/or other interruptions in controlling the process. Further, following such use of the emulations to prepare the monitoring device(s) 1500 for use, the emulations may be employed to test the effectiveness of the monitoring device(s) 1500 in various simulated scenarios to demonstrate their capabilities, provide confidence in the range of their capabilities, and/or ensure that various particular needs of operators of the monitored system 2000 are met.

Still further, such emulations may be used to simulate various conditions that may additionally provide new insights into other aspects of the monitored system 2000, itself, and/or other aspects of the process, itself. In this way, flaws in the logic employed in controlling the process may be revealed that may create a susceptibility to one or more forms of attack and/or failure. Thus, it may be that such emulations go beyond providing proof of the suitability of the monitoring devices 1500 for use, and additionally identify ways in which the monitored system 2000 and/or the process may be improved.

FIGS. 1B-D, taken together, present aspects of the use of the monitored system 2000 to control an example process 3003x being performed within an external system 3000x, and present aspects of the use of monitoring device(s) 1500 of the monitoring system 1000 to monitor and/or actively correct network activity on the network 2999. More specifically, a monitored device 2300x of the multiple monitored devices 2300 of the monitored system 2000 may be coupled to the external system 3000x via one or more links 3999x, while at least one other monitored device 2300a may cooperate with the monitored device 2300x through the network 2999 to control the process 3003x within the external system 3000x. Also, at least one monitoring device 1500 of the monitoring system 1000 may be coupled to at least one interchange device 2700 of the network 2999 to monitor the network traffic between at least the monitored devices 2300a and 2300x for instances of improper network activity that may adversely affect such controlling of the process 3003x.

To be clear, it should be understood that what is depicted in FIGS. 1B-D includes using the monitoring device(s) 1500 of the monitoring system 1000 to monitor and/or correct traffic through the network 2999 at a time after the monitoring device(s) 1500 have been prepared for use by performing the gathering phase, the pre-training phase, and the emulation training phase. As previously mentioned, FIGS. 1E-F, taken together, depict aspects of such preparation of the monitoring device(s) 1500 of the monitoring system 1000 for use. Also, a more detailed discussion of such preparation is provided still later in this present application.

Turning to FIGS. 1B-C, as depicted, the external system 3000x in which an example process 3003x is performed, may include multiple sensing devices 3200 to detect various conditions, and/or multiple effecting devices 3800 able to be commanded to perform various functions. Depending on the nature of the depicted process 3003x that is performed within the external system 3000x, each of the sensing devices 3200 may be any of a variety of type of sensing device based on any of a variety of technologies to sense any of a variety of conditions, including and not limited to, a temperature sensor, pressure sensor, light sensor, vibration sensor, accelerometer, gyroscope, spectrometer, chemical release sensor, particle emission detector, manually-operable control, manual data input device, air speed sensor, RADAR, LIDAR, SONAR, RPM sensor, etc. Correspondingly, depending on the nature of the process 3003x that is performed within the external system 3000x, each of the effecting devices 3800 may be any of a variety of type of effecting device based on any of a variety of technologies to effect any of a variety of actions, including and not limited to, a robotic arm, gantry crane, remotely controllable mobile platform, welding device, metal press, valve, heater, cooler, power supply, magnet or set of magnets, data storage device, display system, aerofoil or hydrofoil control surface, rudder, magnetron, radiation source, electric motor, internal combustion engine, turbine engine, etc.

Thus, in being coupled to the external system 3000x via the link(s) 3999x, the monitored device 2300x may be coupled to the sensing devices 3200 and/or to the effecting devices 3800 of the external system 3000x via the link(s) 3999x. As depicted, and depending on the technologies employed by the link(s) 3999x, it may be that the link(s) 3999x incorporate one or more relay devices 3700x. By way of example, it may be that the relay device(s) 3700x serve to boost signal strength over relatively long electrical and/or optical conductors of the link(s) 3999x, serve as transceiver(s) for one or more wireless connections on which the link(s) 3999x may be based, and/or serve as converter(s) between portions of the link(s) 3999x that may employ different signaling, protocols, transmission media, etc.

The process 3003x that may be performed within the external system 3000x may be any of a variety of types of industrial process (e.g., a chemical process, the automated assembly of a product on an assembly line, the provision of electric power, etc.), or may be any of a variety of types of non-industrial process (e.g., data archival and storage, data mining, etc.). Regardless of what the process 3003x may be, the process 3003x may have multiple states where particular action(s) are to be performed and/or where particular event(s) are to occur within each state. Thus, the performance of the process 3003x may progress through a tree of such states with particular transitions occurring between particular states at particular times, in a particular order, and/or in response to particular conditions.

As depicted, the monitored device 2300x may include one or more processors 2350x, a storage 2360x, a port 2390x to couple the monitored device 2300x to the network 2999, and/or an interface 2393x to couple the monitored device 2300x to the link(s) 3999x. The storage 2360x, the port 2390x and/or the interface 2393x may each be communicatively coupled to the processor(s) 2350x to exchange executable instructions and/or data therewith through the exchange of electrical, optical, magnetic and/or other signals through one or more buses and/or other form of interconnect within the monitored device 2300x. Further, the storage 2360x may store a control routine 2340x that may include instructions executable by the processor(s) 2350x to cause the processor(s) 2350x to perform various functions. In some embodiments, the storage 2360x may also store log data 2330x that may include indications of transmissions to and/or from the external system 3000x via the link(s) 3999x, and/or may include other information associated with those transmissions.

In various embodiments, the control routine 2340x may implement logic 2345x for controlling at least some aspects of performances of the process 3003x within the external system 3000x. It may be that the control routine 2340x is operative on the processor(s) 2350x of the monitored device 2300x to cause the processor(s) 2350x to monitor the sensing devices 3200 of the external system 3000x to monitor aspects of the process 3003x performed within the external system 3000x, and/or to command the effecting devices 3800 of the external system 3000x in a manner that causes the processor(s) 2350x to put the external system 3000x into at least a subset of the multiple states of the process 3003x. In so doing, the effecting devices 3800 of the external system 3000x may be operated in a concerted manner by the monitored device 2300x to perform various steps of the process 3003x, while being guided by data received by the monitored device 2300x from the sensing devices 3200 of the external system 3000x. Stated differently, the control routine 2340x may be capable of causing the processor(s) 2350x to monitor for and/or to implement at least a subset of those multiple states of the process 3003x.

As depicted, the monitored device 2300a may include one or more processors 2350a, a storage 2360a, and/or a port 2390a to couple the monitored device 2300a to the network 2999. The storage 2360a and/or the port 2390a may each be communicatively coupled to the processor(s) 2350a to exchange executable instructions and/or data therewith through the exchange of electrical, optical, magnetic and/or other signals through one or more buses and/or other form of interconnect within the monitored device 2300a. Further, the storage 2360a may store a control routine 2340a that may include instructions executable by the processor(s) 2350a to cause the processor(s) 2350a to perform various functions.

In various embodiments, the control routine 2340a may implement logic 2345a for also controlling at least some aspects of performances of the process 3003x within the external system 3000x. It may be that the control routine 2340a is operative on the processor(s) 2350a of the monitored device 2300a to cause the processor(s) 2350a to transmit operational commands to the monitored device 2300x to control the performance of the process of the external system 3000x based, at least in part, on operational information received from the monitored device 2300x. Stated differently, the control routine 2340a may be capable of causing the processor(s) 2350a to command the occurrence of transitions among at least a subset of the states of the process of the external system 3000x, thereby causing the process to be performed.

Thus, the monitored devices 2300a and 2300x, together, may implement logic 2345a and 2345x that causes the processors 2350a and 2350x, respectively, to cooperate to control the process 3003x. While the monitored device 2300x may be coupled to the external system 3000x so as to be capable of directly monitoring for and/or implementing states of the process 3003x performed therein, it may be that the overall actual performance of the process 3003x is controlled by the monitored device 2300a. In this way, the monitored devices 2300a and 2300x may cooperate to implement the logic of the finite state machine for the process performed within the external system 3000x.

More precisely, it may be that the monitored device 2300a outputs transmissions 2922 onto the network 2999 that convey operational commands and/or operational information to the monitored device 2300x to cause the monitored device 2300x to implement at least a subset of the transitions between states within the external system 3000x. In turn, the monitored device 2300x may output corresponding transmissions 3933 onto the link(s) 3999x to various ones of the effecting devices 3800 that convey commands to act in a manner that causes such transitions. It may also be that the monitored device 2300x receives, via the link(s) 3999x, transmissions 3933 from the effecting devices 3800 confirming receipt and/or performance of such instructions to act, and/or transmissions 3933 from the sensing devices 3200 providing data concerning detected conditions. In turn, the monitored device 2300x may output corresponding transmissions 2922 onto the network 2999 that convey operational information to the monitored device 2300a indicative of data received from the sensing device(s) 3200 to enable the monitored device 2300a to determine when particular ones of such transitions between states of the process 3003x have occurred and/or should occur.

Turning to FIG. 1D, as depicted, each interchange device 2700 of the network 2999 may include one or more processors 2750, a storage 2760, multiple bi-directional ports 2790, and/or a span port 2791. The storage 2760, the ports 2790 and/or the span port 2791 may each be communicatively coupled to the processor(s) 2750 to exchange executable instructions and/or data therewith through the exchange of electrical, optical, magnetic and/or other signals through one or more buses and/or other form of interconnect within each interchange device 2700. Further, the storage 2760 may store a control routine 2740 that may include instructions executable by the processor(s) 2750 to cause the processor(s) 2750 to perform various functions. Alternatively or additionally, a portion of the storage 2760 may be allocated to serve as a buffer 2766.

As previously discussed, each interchange device 2700 may be any of a variety of types of network device. Thus, in some embodiments, the depicted interchange device 2700 may be a relatively simple hub device in which execution of the control routine 2740 by the processor(s) 2750 may cause the processor(s) 2750 to, in response to receiving a transmission 2922 at one of the ports 2790, output the very same transmission 2922 in a broadcasting manner at all other ports 2790. Alternatively, in other embodiments, the depicted interchange device 2700 may be a relatively more sophisticated device in which execution of the control routine 2740 by the processor(s) 2750 may cause the processor(s) 2790 to use internally stored address information associated with each port 2790 to more selectively relay a transmission 2922 received at one port 2750 to just one other port 2750 or just a subset of the other ports 2750.

Regardless of the level of sophistication of the depicted interchange device 2700, it may be that received transmissions 2922 are temporarily stored within the buffer 2766 for a predetermined period of time and/or until there is an indication of success in being relayed onward through the network 2999. This may be done to enable one or more attempts at retransmission to be performed in response to an indication of failure in an initial attempt at relaying onward through the network 2999.

Further, the span port 2791 may be implemented as an output-only port that relays a copy and/or an indication of each transmission 2922 that is received at any port 2790 of the interchange device 2700. Thus, as depicted, the span port 2791 may be coupled to a monitoring device 1500 of the monitoring system 1000 to enable copies and/or indications of some or all traffic that passes through the interchange device 2700 to be provided to that monitoring device 1500. As will shortly be explained in greater detail, this enables that monitoring device 1500 to detect an instance in which a transmission 2922 of a particular operational command and/or operational information among the monitored devices 2300 that was expected to occur within a particular span of time, but which fails to occur. This also enables that monitoring device 1500 to detect an instance in which an improper transmission 2922 of an operational command and/or operational information among the monitored devices 2300 occurs. As additionally depicted, the same depicted monitoring device 1500 may also be coupled to the depicted interchange device 2700 via another of the ports 2790. As will be explained in greater detail, such an additional coupling therebetween may enable the monitoring device 1500 to respond to such an occurrence of a lack of an expected transmission 2922 and/or an occurrence of an improper transmission 2922 by outputting a replacement transmission 2922, itself.

In embodiments in which the interchange device 2700 is of a more sophisticated variety, it may be that execution of the control routine 2740 causes the processor(s) 2750 thereof to respond to commands received from such a monitoring device 1500 to limit the copies and/or indications of network traffic that are provided through the span port 2791 to transmissions 2922 of particular types and/or to transmissions 2922 associated with particular devices. In this way, it may be that the depicted interchange device 2700 is caused to cooperate with the depicted monitoring device 1500 to limit the copies and/or indications of network traffic that are output to the monitoring device 1500 to operational commands and/or operational information transmitted among monitored devices 2300.

Alternatively or additionally, in embodiments in which the interchange device 2700 is of a more sophisticated variety, it may be that the execution of the control routine 2740 causes the processor(s) 2750 thereof to respond to commands received from such a monitoring device 1500 to at least temporarily retain transmissions 2922 meeting one or more specified criteria within the buffer 2766. In this way, it may be that the depicted interchange device 2700 is caused to cooperate with the depicted monitoring device 1500 to at least temporarily delay allowing a transmission 2922 to proceed through the interchange device 2700 from one monitored device 2300 to another monitored device 2300, thereby at least providing the monitoring device 1500 with an amount of time needed to analyze aspects of the transmission 2922 to determine whether it is a proper transmission 2922 so as to be able to determine whether to command the interchange device 2700 to allow it to continue onward to the other monitored device 2300.

As also depicted, each such monitoring device 1500 may include one or more processors 1550, a storage 1560, and/or one or more ports 1590 for coupling to one or more interchange devices 2700 of the network 2999. The storage 1560 and/or the port(s) 1590 may each be communicatively coupled to the processor(s) 1550 to exchange executable instructions and/or data therewith through the exchange of electrical, optical, magnetic and/or other signals through one or more buses and/or other form of interconnect within each monitoring device 1500. Further, the storage 1560 may store a control routine 1540 that may include instructions executable by the processor(s) 1550 to cause the processor(s) 1550 to perform various functions. Alternatively or additionally, the storage 1560 may store a database 1533 of information concerning states, operational commands and/or operational information associated with one or more processes that may be performed within an external system 3000 (e.g., the process 3003x performed within the external system 3000x), as well as information concerning actions to be taken in response to situations observed on the network 2999 that at least appear to fall outside what is expected to occur during the performance of each of those one or more processes.

With the monitoring device(s) 1500 so coupled to the interchange device(s) 2700, the monitoring for improper traffic through the network 2999 may include, and not be limited to: 1) monitoring for instances of a lack of transmission of a particular operational command or particular operational information when expected within a particular span of time; and/or 2) monitoring for instances of a transmission of an improper or invalid operational command.

Regarding the lack of transmission of a particular operational command or particular operational information when expected within a particular span of time, such an instance of failure of transmission may arise for any of a variety of reasons. Among those reasons may be any of a variety of hardware and/or software malfunctions that may have occurred within a particular monitored device 2300 such that it is no longer functioning sufficiently to transmit the operational command or information, as expected. Alternatively or additionally, among those reasons may be a cyber attack in which a particular monitored device 2300 that was to transmit the operational command or information through the network 2999 has succumbed to malicious software or other form of internal cyber attack that prevents it from doing so, and/or has been inundated with network activity through the network 2999 such that it is prevented from transmitting the operational command or operational information.

Again, there may be particular transmissions 2922 of operational commands and/or operational information through the network 2999 that are associated with various transitions between states of such a process within an external system 3000. By way of example, it may be that a particular operational command or operational information is meant to be transmitted through the network 2999 within a particular span of time in response to the occurrence of particular conditions, such as a transition into a particular state. Or, by way of another example, it may be that a particular operational command or operational information is meant to be transmitted through the network 2999 within a particular span of time, and/or as part of a particular sequence of operational commands and/or operation information, to cause a transition into a particular state. Thus, a failure of one of those transmissions to occur when expected within a particular span of time may result in a failure of occurrence of a transition between states that would otherwise normally take place, and/or may result in an errant transition to an incorrect state.

The monitoring device(s) 1500 of the monitoring system 1000 may be configured to respond to such a failure of occurrence of the transmission of a particular operational command or information through the network 2999 by taking any of a variety of actions. By way of example, in some embodiments, the monitoring device(s) 1500 may simply provide an alert to designated personnel of such a failure (e.g., providing an audible and/or visual alert, and/or transmitting an electronic alert message, such as a text message or phone call). Alternatively or additionally, in other embodiments, the monitoring device(s) 1500 may store, in a log or other similar data structure maintained within the storage 2760, an indication of such a failure. Also alternatively or additionally, in still other embodiments, the monitoring device(s) 1500 may, through the interchange device(s) 2700, transmit that particular operational command or operational information through the network 2999, itself, such that the particular operational command or operational information is still provided to whichever other monitored device 2300 is supposed to receive it, thereby enabling the associated industrial process or other type of process to continue without interruption.

Regarding the transmission of an improper or invalid operational command, such an instance of improper transmission may also arise for any of a variety of reasons. Among those reasons may be an honest operator mistake, or any of a variety of hardware and/or software malfunctions that may have occurred within the a particular monitored device 2300 such that it is no longer functioning sufficiently to select correct operational commands and/or information to be transmitted. Alternatively or additionally, among those reasons may be that the monitored device 2300 that transmits the improper operational command or information has succumbed to malicious software or other form of cyber attack that either, itself, causes the particular monitored device 2300 to transmit the improper operational command, or enables the monitored device 2300 to be remotely commanded to do so. It should also be noted that such an instance of improper transmission may arise elsewhere within and/or proximate to the network 2999, such interfering electrical activity caused by a lightning strike, etc. such that the contents of a proper transmission may have been corrupted.

Again, there may be particular transmissions 2922 of operational commands and/or operational information through the network 2999 that are associated with various transitions between states of such a process within an external system 3000. Thus, a transmission of an improper operational command to take an improper action, or to take an action with improper parameter(s), may result in a transition to another state that occurs out of proper sequence, or may result in a transition to an improper state that is entirely outside of such a tree.

The monitoring device(s) 1500 of the monitoring system 1000 may be configured to respond to the transmission of such an improper operational command through the network 2999 by taking any of a variety of actions. By way of example, in some embodiments, the monitoring device(s) 1500 may simply provide an alert to designated personnel of such a transmission (e.g., providing an audible and/or visual alert, and/or transmitting an electronic alert message, such as a text message or phone call). Alternatively or additionally, in other embodiments, the monitoring device(s) 1500 may store, in a log or other similar data structure maintained within the storage 2760, an indication of such a transmission. Also alternatively or additionally, in still other embodiments, the monitoring device(s) 1500 may, through the interchange device(s) 2700, block the transmission of such an improper operational command such that it is not received at whichever monitored device 2300 was the intended destination, and/or cause the transmission of a proper operational command that replaces and/or countermands the improper operational command.

More precisely, in some embodiments, it may be that the monitoring device(s) 1500 operate the interchange device(s) 2700 to cause the interchange device(s) 2700 to intercept each operational command that is transmitted by one of the monitored devices 2300 that meets various pre-selected parameters (e.g., type of operational command, protocol used, destination, etc.). Each such operational command may initially be relayed to the monitoring device(s) 1500 for analysis, instead of being relayed onward to its intended destination. The analysis that is performed may be based on machine learning where correct transmissions of operational commands associated with controlling industrial processes through the network 2990 have been observed over time to build up a knowledge base of what transmissions of operational commands are expected to occur and when. Where the analysis results in a determination that the operational command is proper, then the interchange device(s) 2700 may be directed to proceed with relaying the operational command onward towards its intended destination. However, where the analysis results in a determination that the operational command is improper or invalid, then, at a minimum, the interchange device(s) 2700 may be directed to refrain from relaying the operational command onward towards its intended destination.

Still further action may be taken by the monitoring device(s) 1500 in response to an improper operational command based on various factors. By way of example, where a transmitted improper or invalid operational command is the type of operational command that is expected, is transmitted at the expected time, and to the expected destination, but includes wrong parameter(s), then the monitoring device(s) 1500 may transmit a corrected version of that improper operational command, through interchange device(s) 2700, and onward to the same destination, so as to cause the proper operational command to be received at that destination at the expected time.

Alternatively, in other embodiments, it may be that the interchange device(s) 2700 do not, in any way, intercept the operational commands that are transmitted therethrough. Instead, for each operational command that is transmitted by one of the monitored devices 2300 that meets various pre-selected parameters (e.g., type of operational command, protocol used, destination, etc.), a copy is relayed to the monitoring device(s) 1500 for analysis as it is also relayed onward to its intended destination. Again, the analysis that is performed may be based on machine learning or by a comparison against a database of expected operational commands. Where the analysis results in a determination that the operational command is proper, then no further action may be taken. However, where the analysis results in a determination that the operational command is improper, then further action may be taken by the monitoring device(s) 1500, such as sending an alert or transmitting an additional operational command(s), through interchange device(s) 2700, and onward to the same destination. The additional operational command(s) may be generated based on an analysis of the improper or invalid operational command to countermand the action specified in the improper operational command.

FIGS. 1E-F, taken together, present aspects of the preparation of the monitoring system 1000 for use in monitoring and/or correcting network communications occurring on the network 2999 of the monitored system 2000 that are associated with controlling the process 3003x being performed within the external system 3000x. More specifically, information gathered about the monitored system 2000 and/or the external system 3000x is provided to one or more emulation devices 5500 of the emulation system 5000 to enable the provision of a set of emulations of different portions of the systems 2000 and/or 3000x. In so doing, an emulation of network activity through the network 2999 may also be provided, and may be used to train and/or test the one or more monitoring devices 1500 as part of preparing those monitoring device(s) 1500 for such use.

Turning to FIG. 1E, during a gathering phase, one or more gathering devices 5700 may be temporarily coupled, via at least one link 5992, to span port(s) 2791 of interchange device(s) 2700 of the network 2999 of the monitored system 2000. Through the link(s) 5992, and in a manner similar to what was described in reference to FIG. 1D for the monitoring device(s) 1500, the gathering device(s) 5700 may receive indications of transmissions 2922 occurring on the network 2999. Also in a manner similar to what was described in reference to FIG. 1D for the monitoring device(s) 1500, the indications of transmissions 2922 received by the gathering device(s) 5700 through the link(s) 5992 may be limited to transmissions 2922 that are associated with controlling the process 3003x that is performed within the external system 3000x.

Additionally, in some embodiments, it may be that the gathering device(s) 5700 are also temporarily coupled, via at least one link 5993, to either the relay device(s) 3700x (if present) or to the monitored device 2300x. As previously discussed, based on the type(s) of communications technology employed by the link(s) 3999x, it may be that the link(s) 3999x incorporate the relay device(s) 3700x to boost signals by which the transmissions 3933 are conveyed, and/or to convert between differing protocols and/or differing transmission media used by the link(s) 3999x. Further, it may be that the relay device(s) 3700x also incorporate span port(s) to which the gathering device(s) 5700 may simply be temporarily coupled via the at least one link 5993 in a manner similar to the span port(s) 2791 of the interchange device(s) 2700.

Alternatively, in other embodiments in which the link(s) 3999x do not incorporate the relay device(s) 3700x, it may be deemed desirable to avoid attempting to couple the gathering device(s) 5700 to the link(s) 3999x, at all. As those skilled in the art will readily recognize, it may be deemed desirable to not risk causing disruptions to the ability of the link(s) 3999x to convey transmissions 3933 therethrough, and to employ an alternate approach to obtaining information concerning those transmissions 3933, if an alternate approach is available. Such an alternate approach may be to couple the gathering device(s) 5700 to the monitored device 2300x to obtain a copy of the log data 2330x that may be generated therein, which may include various details of transmissions 3933 to and from the external system 3000x.

As those skilled in the art will readily recognize, each of the monitored devices 2300, including the monitored devices 2300a and 2300x, may be any of a wide variety of types of computing device based on any of a variety of implementations of any of a variety of computing architectures. Among such a wide assortment of options for implementing the monitored device 2300x, a subset of those options may be configured and/or configurable to generate the log data 2330x to include any of a variety of types of information concerning any of variety of types of event that may occur while controlling the process 3003x within the external device 3000x. By way of example, in some of such embodiments, it may be that the log data 2330x is limited to recording instances of anomalies and/or improper conditions that might occur during individual performances of the process 3003x, such as instances of exceeding ranges of temperature, pressure, speed, capacity, timing, etc. However, by way of another example, it may be that the log data 2330x is far more verbose such that indications of each transmission 3933 that is sent or received by the monitored device 2300x may be recorded therein, along with timestamps thereof. In embodiments in which such verbose log data 2330x is generated, it may be possible to use the log data 2330x in lieu of direct observations of the transmissions 3933 through the link(s) 3999x.

Regardless of the exact manner in which information concerning transmissions 3933 through the link(s) 3999x is captured or otherwise obtained (if that is possible) in addition to information concerning transmissions 2922 through the network 2999, the captured information concerning transmissions 2922 and/or 3933 may be stored within at least one gathering device 5700 as the observation data 5730. As will shortly be explained, following this gathering phase in which the observation data 5730 is so generated to include information for such transmissions 2922 and/or 3933 occurring over a pre-determined period of time, the observation data 5730 may then be provided to the one or more emulating devices 5500 of the emulation system 5000 as an input to a pre-training phase.

As depicted, each gathering device 5700 may include one or more processors 5750, a storage 5760, and/or one or more ports 5790 for being temporarily coupled to at least interchange device(s) 2700 of the network 2999. The storage 5760 and/or the port(s) 5790 may each be communicatively coupled to the processor(s) 5750 to exchange executable instructions and/or data therewith through the exchange of electrical, optical, magnetic and/or other signals through one or more buses and/or other form of interconnect within each monitoring device 1500. Further, the storage 5760 may store the observation data 5730 and/or a control routine 5740 that may include instructions executable by the processor(s) 5750 to cause the processor(s) 5750 to perform various functions.

More specifically, in executing the control routine 5740, the processor(s) 5750 of the gathering device(s) 5700 may be caused to monitor the port(s) 5790 for the receipt of indications of transmissions 2922 occurring on the network 2999. Additionally, in some embodiments, the processor(s) 5750 may be caused to monitor the port(s) 5790 for the receipt of either indications of transmissions 3933 occurring through the link(s) 3999x, or the log data 2330x. In response, the processor(s) 5750 may be caused to combine such received information concerning transmissions 2922 and/or 3933, along with information concerning when each such transmission occurred, to generate the observation data 5730.

Referring to FIG. 1A, in addition to FIG. 1E, it should be noted that, in an alternate embodiment, the emulation system 5000 may not include the gathering device(s) 5700, and it may be that the monitoring device(s) 1500 are employed to perform the functions of the gathering device(s) 5700. More precisely, in such an alternate embodiment, and at a time prior to the monitoring device(s) 1500 being prepared for use in monitoring and/or correcting network traffic on the network 2999, it may be that the monitoring device(s) 1500 are able to be operated in a gathering mode during the gathering phase to receive indications of transmissions 2922 occurring on the network 2999, and generating the observation data 5730 in a manner similar to what has been described in reference to the gathering device(s) 5700. In such an alternate embodiment, the monitoring device(s) 1500 may then be temporarily coupled to the emulation device(s) 5500 to both provide the observation data 5730 thereto as part of completing the gathering phase, and to be trained and/or tested as part of the training phase, as has been described.

In another alternate embodiment, it may be that one or more of the monitored devices 2300 (e.g., one or both of the monitored devices 2300a and 2300x) are employed to perform the functions of the gathering device(s) 5700. More precisely, processor(s) 2350 within each such monitored device 2300 may caused, by execution of a portion of the control routine 2340, to generate and store at least a portion of the observation data 5730 to include indications of network traffic through the network 2999 that it has output and/or that it has received. Such portions of the observation data 5730 may then be subsequently combined to form the completed observation data 5730, which may then be provided to the emulation device(s) 5500.

In still another embodiment, it may be that the interchange device(s) 2700 of the network 2999 are employed to perform the functions of the gathering device(s) 5700. More precisely, processor(s) 2750 within each such interchange device 2700 may caused, by execution of a portion of the control routine 2740, to generate and store at least a portion of the observation data 5730 to include indications of network traffic that passes therethrough. Again, such portions of the observation data 5730 may then be subsequently combined to form the completed observation data 5730, which may then be provided to the emulation device(s) 5500.

Turning to FIG. 1F, following the gathering phase, and during a pre-training phase, the gathering device(s) 5700 that had been temporarily coupled to at least the monitored system 2000 to gather information concerning at least transmissions 2922 associated with controlling the process 3003x within the external system 3000x, may be uncoupled therefrom, and may then be temporarily coupled, via a network 5999, to one or more emulation device(s) 5500. In this way, the emulation device(s) 5500 may be provided with the observation data 5730 generated by the gathering device(s) 5700.

Also, the emulation device(s) 5550 may be provided with device data 5530 that is indicative of characteristics of various monitored devices 2300 (e.g., at least the monitored devices 2300a and 2300x), and/or the logic employed by those various monitored devices 2300 in controlling the process 3003x performed within an external system 3300x. In some embodiments, the device data 5530 may also include details of a state machine descriptive of the process 3003x. However, in other embodiments, the details of such a state machine may not be available to be provided to the emulation device(s) 5500 such that it may need to be derived.

As depicted, each such emulation device 5500 may include one or more processors 5550, a storage 5560, and/or one or more ports 5590 for coupling to the network 5999. The storage 5560 and/or the port(s) 5590 may each be communicatively coupled to the processor(s) 5550 to exchange executable instructions and/or data therewith through the exchange of electrical, optical, magnetic and/or other signals through one or more buses and/or other form of interconnect within each emulation device 5500. Further, the storage 5560 may store a control routine 5540 that may include instructions executable by the processor(s) 5550 to cause the processor(s) 5550 to perform various functions. Alternatively or additionally, the storage 5560 may store the observation data 5730, the device data 5530, and/or a database 5533. Also alternatively or additionally, portions of the storage 5560 may be allocated to serve as virtual machines (VMs) or containers 5566 to provide emulations.

As will be explained in greater detail, during the pre-training phase, execution of the instructions of the control routine 5540 may cause processor(s) 5550 of the emulation device(s) 5500 to use the information in the observed data 1530 concerning observed transmissions 2922 and/or 3933, together with information in the device data 5530 concerning logic and/or state machines to generate, within each VM or container 5566, an emulation of a separate device or other component that is present within the monitored system 2000 or the external system 3000x. These may include separate emulations for each of the monitored devices 2300a and 2300x, an/d/or an emulation of the process 3003x and/or the external system 3000x in which the processor 3003x is performed. These VMs or containers 5566 may be linked to enable the separate emulations within each VM or container 5566 to interact in a cooperative manner to provide an emulation of the monitored system 2000 and the external system 3000x interacting with each other. In so doing, an emulation may also be provided of at least the communications activity occurring through the network 2999, if not also through the link(s) 3999x.

As will also be explained in greater detail, following the pre-training phase, and during an emulation training phase, these emulations may be used in preparing the monitoring device(s) 1500 to distinguish between proper network activity on the network 2999, and improper network activity suggestive of a malfunction and/or cyber attack where the monitoring device(s) 1550 should take some form of action. As will be explained in greater detail, it may be that the monitoring device(s) 1500 are also prepared to distinguish network activity that is indicative of an error condition where the monitoring device(s) 1550 should not take action, and instead, allow the logic of other devices (e.g., one or more monitored devices 2300) to take action.

In commencing the training phase, the monitoring device(s) 1500 may be temporarily coupled, via at least one link 5991, to port(s) 5590 of the emulation device(s) 5500. The processor(s) 5550 may be caused by execution of the control routine 5540 to provide, at the port(s) 5590, access to the emulation of at least the communication activity through the network 2999. In this way, the monitoring device(s) 1500 may be subjected to conditions that are at least relatively similar to the conditions that will be encountered when coupled to at least the actual interchange device(s) 2700 of the network 2999.

Following the emulation training phase, the monitoring device(s) 1500 may be uncoupled from the emulation device(s) 5500, and may then be coupled, via the link(s) 1992, to the interchange device(s) 2700 of the network 2999 of the monitored system 2000 for use. As will be explained in greater detail, the emulation training phase is meant to at least minimize (if not eliminate) the need for further training of the monitoring device(s) 1500 upon being so coupled to the actual monitored system 2000 for use. In this way, at least the potential for disruptions of the normal operation of the monitored system 2000 to control the process 3003x may be at least minimized, if not eliminated.

Returning to FIG. 1A, although the monitored system 2000 has been discussed as being made up of multiple networked computing devices 2100, 2300 and/or 2700, in alternate embodiments, it may be that the monitored system 2000 is, itself, a single computing device. In such alternate embodiments, the device(s) 2100, 2300 and/or 2700 may be components of that single computing device that are interconnected by an internal network of buses 2999. In such alternate embodiments, it may be that each of the one or more interchange devices 2700 is an integrated circuit providing a form of crosspoint switch function for the network of buses 2999 by which commands and/or data are transmitted among the other devices 2100 and/or 2300.

Further, in such alternate embodiments, it may additionally be that the monitoring system 1000 is implemented using one or more microcontrollers that may be physically incorporated into the single computing device of the monitored system 2000. However, it may also be that the monitoring system 1000 is otherwise isolated from the central processing units (CPUs) thereof of that single computing device.

Still further, and regardless of whether the monitored system 2000 is made up of multiple networked computing devices, or is, itself, a computing device, it may be that the monitoring system 1000 is implemented via public or private cloud-based network computing resources.

### Further Detail of Network Communications

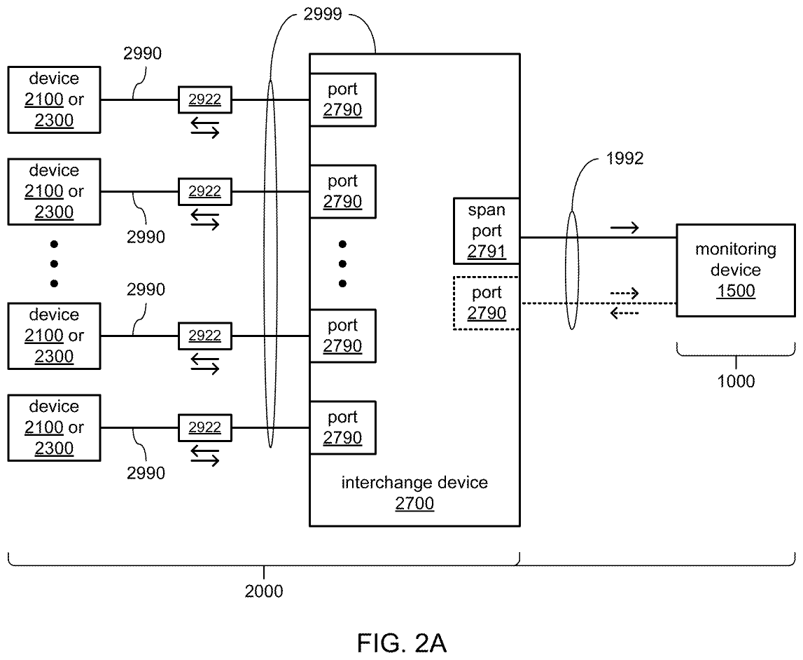

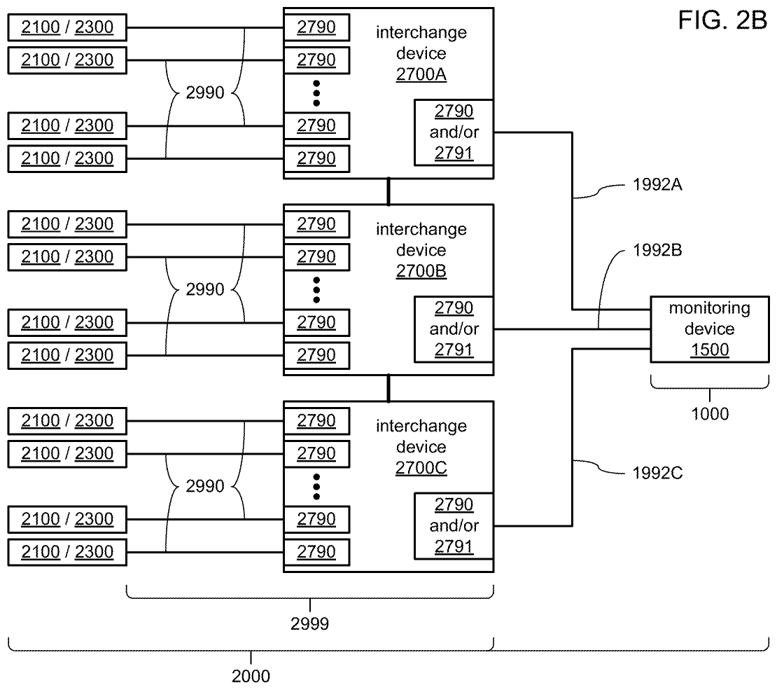

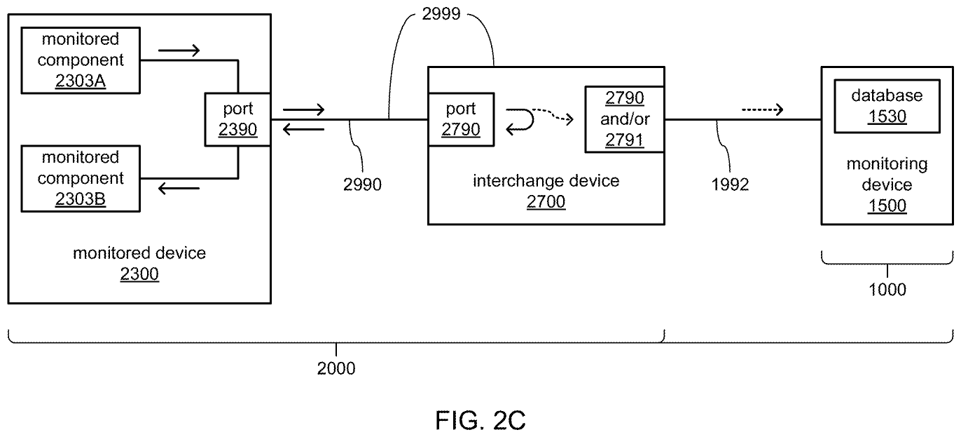

FIGS. 2A, 2B and 2C, taken together, present various aspects of example implementations of the network 2999, including example implementations of the interchange device(s) 2700.

Turning to FIG. 2A, each of the ports 2790 of an interchange device 2700 of the one or more interchange devices 2700 may be coupled by a separate link 2990 to a separate unmonitored device 2100 or monitored device 2300. As those skilled in the art will readily recognize, this may create a form of hub-and-spoke topology, or other electrically similar topology, in which an interchange device 2700 may be at the center of a set of point-to-point connections to a corresponding set of multiple devices 2100/2300. Turning briefly to FIG. 2B, along with FIG. 2A, in larger embodiments of the monitored system 2000, it may be that multiple interchange devices 2700 are coupled together to form a larger version of such a hub-and-spoke topology.

Returning to FIG. 2A, for each monitored system 2000, the span port 2791 of at least a single interchange device 2700 may be coupled by a separate link 1992 to at least a single monitoring device 1500 of a monitoring system 1000. As the devices 2100 and/or 2300 of the monitored system 2000 engage in communications thereamong through the network 2999, copies and/or indications of at least operational commands and/or operational information that are transmitted among at least the monitored devices 2300 may be relayed to the one or more monitoring devices 1500 via the span port(s) 2791 and links 1992. In some embodiments, it may be that such a single monitoring device 1500 is additionally or alternatively coupled, by another link 1992, to a bi-directional port 2790 of such a single interchange device 2700 to enable the single monitoring device 1500 to control one or more the interchange devices 2700 and/or to transmit an operational command or operational information to a monitored device 2300 therethrough.

Turning again briefly to FIG. 2B, along with FIG. 2A, where there are multiple interchange devices 2700 incorporated into an embodiment of the monitored system 2000, it may be that each one of the multiple interchange devices 2700 incorporates a separate span port 2791. The span port 2791 of each of those multiple interchange devices 2700 may then be separately coupled by a separate link 1992 to one or more monitoring devices 1500 of the monitoring system 1000 of that embodiment, thereby enabling each one of those multiple interchange devices 2700 to directly relay copies and/or indications of at least operational commands and/or operational information that are transmitted among at least the monitored devices 2300 thereto. Alternatively, it may be that just a single one of those multiple interchange devices 2700 is so coupled to a single monitoring device 1500, and that single interchange device 2700 may relay copies and/or indications of such operational commands and/or operational information conveyed through all of the multiple interchange devices 2700 through the single span port 2791 and single link 1992.

Regardless of the quantity of interchange devices 2700 and/or the exact manner in which those interchange device(s) 2700 are coupled to one or more monitoring devices 1500, as previously discussed, the interchange device(s) 2700 may include the ability to be programmed to specify a particular subset of transmissions 2922 through the network 2999 for which copies and/or indications thereof are relayed to the monitoring device(s) 1500. Such a subset may be specified by identifiers of devices involved, types of transmission, types of protocol used, size of what is transmitted, time of day or day of week of transmissions, etc. Indeed, in some embodiments, it may be the use of identifiers of devices in defining such a subset that effectively defines which devices within the monitored system 2000 are the monitored devices 2300, versus which devices are the unmonitored devices 2100.

In embodiments in which the monitored system 2000 is made up of a set of networked computing devices, each link 2990 and/or 1992 may be implemented using any of a variety of wireless and/or cabling-based network technologies, including and not limited to, Bluetooth, Wi-Fi, cellular signaling, twisted-pair electrical cabling, coaxial electrical cabling, and fiber optic cabling. Such wireless and/or cabling-based technologies may adhere to any of a wide variety of specifications, including and not limited to, Ethernet and/or TCP/IP. In embodiments in which the monitored system 2000 is made up of a single computing device, each link 2990 and/or 1992 may be implemented using any of a variety of widely used and accepted internal bus specifications, including and not limited to, PCI-Express bus, and I²C bus.

Turning to FIG. 2C, in some embodiments, it may be that a monitored device 2300 includes multiple components 2303 where transmissions 2922 of operational commands or operational information thereto and/or therefrom are at least able to be observed through the link 2990 by which that monitored device 2300 is coupled to an interchange device 2700. More specifically, it may be that a single monitored device 2300 incorporates multiple components 2303 that are each able to be separately addressed and communicated with through that link 2990 in a manner almost akin to being entirely separate devices. Alternatively or additionally, it may be that transmissions 2922 of operational commands or operational information among multiple components 2303 within a single monitored device 2300 are also reflected on that link 2990.

Thus, and by way of example, where the depicted monitored component 2303A of the depicted monitored device 2300 transmits an operational command or operational information to another depicted monitored component 2303B within the same monitored device 2300, a copy of that transmission 2922 may also be transmitted onto the depicted link 2990, thereby enabling the depicted interchange device 2700 to relay a copy and/or indication of that transmission 2922 onward to the depicted monitoring device 1500. As still another alternative, it may be that such a transmission 2922 between the depicted monitored components 2303A and 2303B is performed by the monitored component 2303A transmitting the operational command or operational information out to the depicted interchange device 2700, followed by the interchange device 2700 relaying that operational command or operational information back along the same link 2990 to the monitored component 2303B.

Regardless of the exact manner in which transmissions 2922 of operational commands or operational information are relayed to the monitoring device(s) 1500 of the monitoring system 1000, as will shortly be explained in greater detail, the copies and/or indications of operational commands or operational information that are so relayed may be compared to information stored within the database 1533 concerning what transmissions 2922 of operational commands or operational information are expected to occur (and when) as part of identifying instances in which observed transmissions 2922 of operational commands or operational information deviate from what is expected.

### Detail of Correlations Between Network Communications and Process States

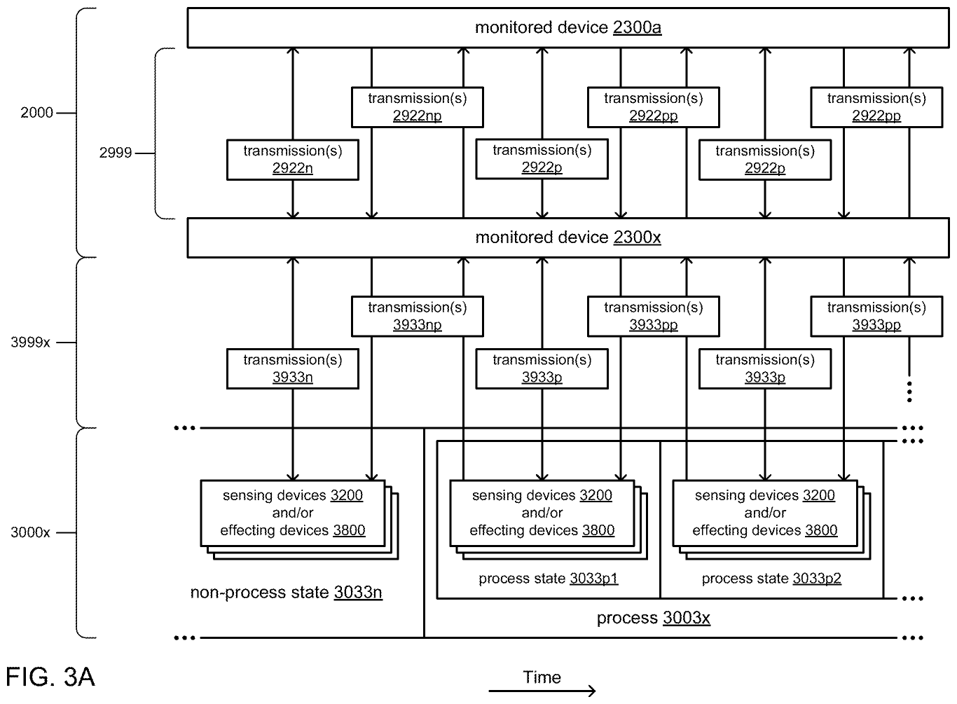

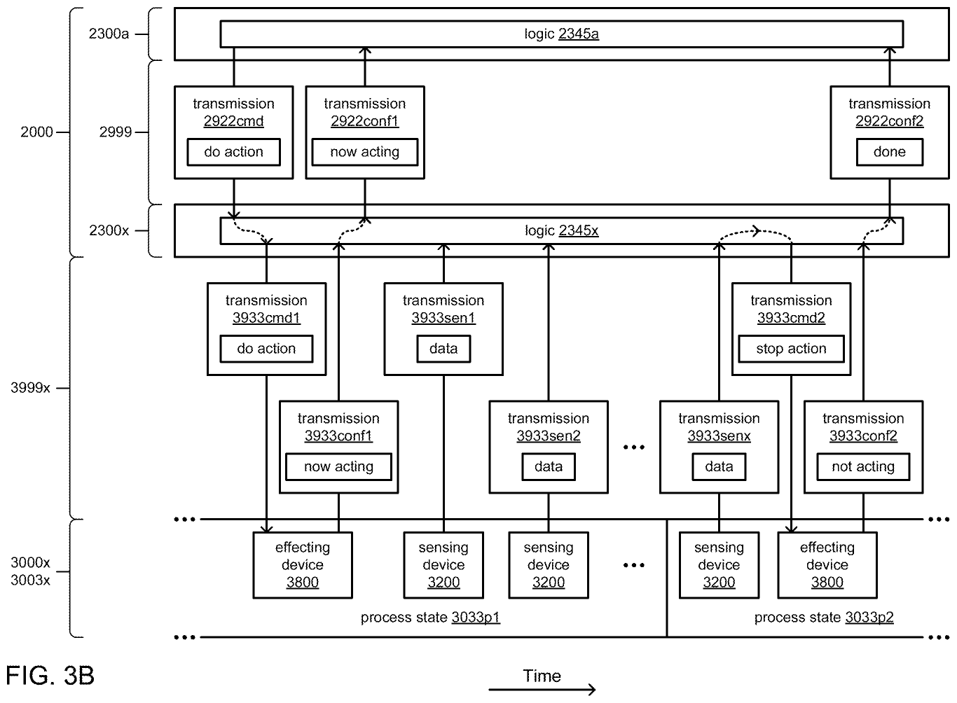

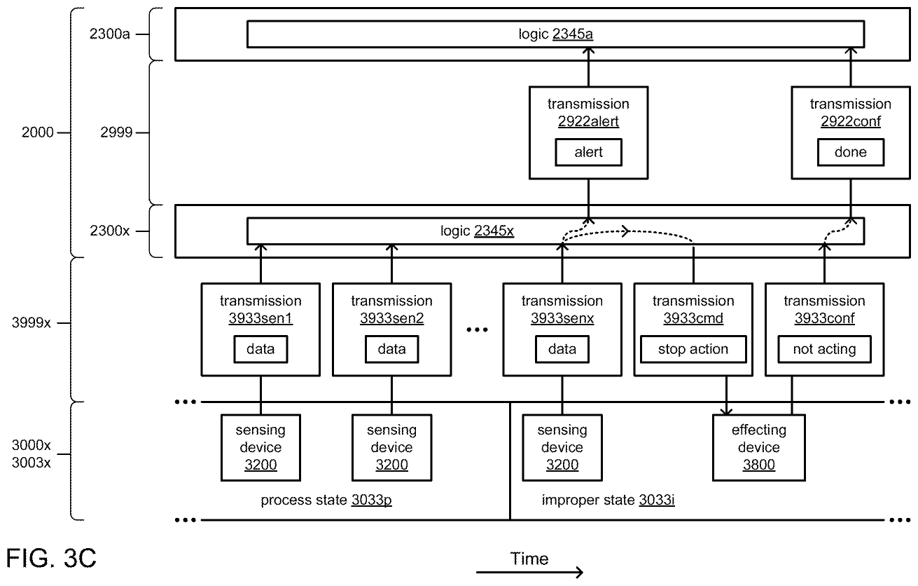

FIGS. 3A, 3B and 3C, taken together, present various aspects of the manner in which transmissions, a process state machine, and logic employed within devices interact to control a performance of a process (e.g., the earlier-introduced example process 3003x).

Turning to FIG. 3A, as previously discussed, and as depicted, a process performed within one of the external systems 3000 may be defined as having a tree of multiple states that is traversed during its performance, such as the depicted process states 3033p1, 3033p2, etc., of the depicted process 3003x performed within the depicted external system 3000x. As also previously discussed, such an external system as the depicted external system 3000x may include one or more sensing devices 3200 to monitor various aspects of the process 3003x performed therein, and/or one or more effecting devices 3800 to effect various aspects of a performance of the process 3003x therein.

As also previously discussed, one or more transmissions 2922 through the network 2999, and one or more corresponding transmissions 3933 through the link(s) 3999x, may be associated with the beginning of a performance of the process 3003x. More specifically, in various embodiments, there may be one or more transmissions 2922np and/or 3933np that trigger the commencement of the process 3003x. By way of example, there may be transmission(s) 2922np that convey operational command(s) between monitored devices 2300 (e.g., the depicted monitored devices 2300a and 2300x) through the network 2999 to prepare for beginning the process 3003x, and/or to actually begin the process 3003x. Such operational command(s) to the monitored device 2300x may, in turn, cause one or more effecting devices 3800 to be commanded with corresponding transmission(s) 3933np through the link(s) 3999x to perform operations that implement such preparations, and/or that actually begin the process 3003x, thereby causing a transition from a non-process state 3033n to the depicted first process state 3033p1 of the process 3003x.

Alternatively, it may be that the process 3003x is responsive to external inputs such that the beginning of a performance of the process 3003x may be triggered in a manner that is not based on such transmissions. Thus, from the perspective of the network 2999 and the link(s) 3999x, it may be that the first transmission associated with a performance of the process 3003x is a transmission indicating that the process 3003x has already begun. By way of example, there may first be transmission(s) 3933np through the link(s) 3999x that convey operational information that preparations for beginning the process 3003x have been completed, and/or that the process 3003x has begun such that the transition from the depicted non-process state 3033n to the first process state 3033p1 has already occurred. Such operational information to the monitored device 2300x may, in turn, cause corresponding transmission(s) 2922np between the monitored devices 2300a and 2300x to relay such operational information onward to the monitored device 2300a. Such operational information may include data collected by one or more sensing devices 3200 at a time immediately preceding, during and/or immediately after the transition to the process state 3033p1.

It should be noted that, during the depicted non-process state 3033n prior to the process 3003x being triggered to begin, there may be one or more transmissions 3400n that are not associated within performing the process 3003x, such as the depicted one or more transmissions 3933n. Such transmissions 3933n may be associated with maintaining the external system 3000x in the depicted non-process state 3033n, such as a distinct “off” state, a “sleep” state, or a “standby” state. As will be familiar to those skilled in the art, such a non-process state 3033n may be configured to minimize the consumption of energy, to maintain device(s) in a known inactive state, and/or to maintain substance(s) in a known safe storage state. Such a minimal consumption of energy may be directed toward maintaining a cache of pre-loaded data in readiness for a future performance of the process 3003x, and/or such a safe storage state may preserve substances in a condition for use in a future performance of the process 3003x.

By way of example, there may be transmission(s) 2922n that convey operational command(s) between monitored devices 2300a and 2300x through the network 2999 to effect and/or maintain the non-process state 3033n. Such operational command(s) may, in turn, cause one or more effecting devices 3800 to be commanded via transmission(s) 3933n to perform operations that implement and/or maintain various aspects of the non-process state 3033n. Alternatively or additionally, there may be transmission(s) 3933n through the link(s) 3999x, and corresponding transmissions 2922n through the network 2999 that convey operational information to the monitored device 2300a concerning aspects of maintaining the non-process state 3033n. Such operational information may include data collected by one or more sensing devices 3200 about the ongoing preservation of data, and/or about the ongoing preservation of substance(s) in storage.

For purposes of monitoring transmissions that pass through the network 2999 as an approach to monitoring the performance of a process, such as the example process 3003x, it may be that a particular transmission 2922n associated with the non-process state 3033n, a particular transmission 2922np associated with the transition from the non-process state 3033n to the process state 3033p1, or a combination of multiple transmissions 2922n and/or 2922np, is selected to serve as an indication that is observable on the network 2999 that the process 3003x has begun. Thus, by monitoring transmissions 2922 occurring on the network 2999 (through one or more interchange devices 2700), a monitoring device 1500 may identify instances in which such particular transmissions 2922n and/or 3922np (or such a combination thereof) have occurred on the network 2999, and use such instances as an indication of when to begin monitoring the network 2999 for transmissions 2922 associated with the process 3003x.

Just as some transmissions 2922 and/or 3933 may be associated with the beginning of a performance of a process, others may be associated with the performance progressing between process states. Returning to the example process 3003x, there may be various transmissions 3933pp via the link(s) 3999x and/or transmissions 2922pp via the network 2999 that may be associated with transitioning between the process states 3033p1 and 3033p2. More precisely, there may be transmissions 2922pp and/or 3933pp that are associated with the process state 3033p1 ending (with a presumption of the next process state beginning), and/or there may be transmissions 2922pp and/or 3933pp that are associated with the process state 3033p2 beginning (with a presumption of the preceding process state having ended). Somewhat similar to the aforedescribed commencement of the process 3003x, this may arise from the fact that some transmissions 2922pp and/or 3933pp may trigger the ending of the process state 3033p1, some may be caused to occur by the ending of the process state 3033p1, some may trigger the beginning of the process state 3033p2, and some may be caused to occur by the beginning of the process state 3033p2. Also in a manner somewhat similar to the commencement of the process 3003x, the transmission(s) 2922pp and/or 3933pp that trigger the beginning or the ending of a process state may do so by conveying operational command(s) that cause effecting device(s) 3800 to be commanded to perform operations that effectuate such a beginning or ending. Correspondingly, transmissions that are caused to occur by the beginning or the ending of a process state may convey operational information that includes data collected by one or more sensing devices 3200 associated with such a beginning or ending.

Additionally, during a process state (e.g., during one of the depicted process states 3033p1 or 3033p2), there may be transmissions 2922p that convey operational commands and/or operational information between the monitored devices 2300a and 2300x, and/or corresponding transmissions 3933p between the monitored device 2300x and either or both of the sensing device(s) 3200 and/or the effecting device(s) 3800. Again, such transmissions may convey operational information that may include data collected by sensing devices 3200 that is indicative of various measurements associated with a portion of the process 3003x that occurs during a process state. Alternatively or additionally, such transmissions may convey operational commands that cause effecting device(s) 3800 to perform various operations during a process state.

As previously discussed, for the example process 3003x performed within the external system 3000x, the monitored devices 2300a and 2300x, together, may implement the logic for controlling the progression of those performances through the various process states thereof. As part of exerting such control, the logic implemented within each of the monitored devices 2300a and 2300x functions in a manner that is at least partially responsive to received inputs. While such inputs may include transmissions 2922 and/or 3933 originating from within the monitored system 2000 and/or the external system 3000x, others of such inputs may be external inputs that originate entirely outside of both systems 2000 and 3000x. By way of example, the monitored device 2300a may provide a user interface (not specifically shown) that may be operable to enable manual control of when a performance of the process 3003x commences and/or other aspects thereof. By way of another example, components and/or devices within the external system 3000x may be subject to external influences (e.g., availability of various external resources, weather conditions, etc.) that may constrain, enable and/or disable various aspects of the process 3003x. Further, regardless of what each such external input may be, the timing of each such external input may at least partially determine what effect it has on a performance of the process 3003x.

FIGS. 3B and 3C present differing examples of responses by the logic 2345a and 2345x implemented within the monitored devices 2300a and 2300x, respectively, to various combinations of such internal and external inputs. As each of these two figures makes clear, and as will be explained in greater detail, there are time delays inherent in implementing such logic to be taken into account in providing emulations of computing devices that implement such logic, such as the monitored devices 2300a and 2300x.

Turning to FIG. 3B, the monitored device 2300a may implement a UI (not specifically shown) by which an operator of the monitored device 2300a may manually input a command to cause the process 3003x being performed within the external system 3000x to progress from process state 3033p1 to process state 3033p2. By way of example, such an operator may enter a command to perform an action such as heat a tank filled with water in the external system 3000x.

It is important to note that the timing of such manual input by the operator may be extremely difficult, if not impossible, to predict. This, in turn, may make the timing of when the first transmission in the following series of transmissions similarly difficult to predict. However, the timings of at least some of the following transmissions relative to each other may be far more easily predicted, as will be explained in greater detail.

In response to receiving such manually entered input from the operator, the logic 2345a implemented within the monitoring device 2300a may cause the monitored device 2300a to output a transmission 2922cmd onto the network 2999 that conveys an operational command to the monitored device 2300x to do the commanded action (e.g., heat a tank). As will be explained in greater detail, such a response to such manual input may be an example of a causal relationship implemented as part of the logic 2345a within the monitored device 2300a for controlling the process 3003x.

In response to receiving the transmission 2922cmd, the monitored device 2300x may relay the operational command to do the commanded action onward in a transmission 3933cmd1 to the an effecting device 3800 of the external system 3000x via the one or more communication links 3999x. As depicted, there is a time delay within the monitored device 2300x between the time of receipt of the transmission 2922cmd and the time of output of the transmission 3933cmd1.

As will be explained in greater detail, this relaying of the operational command, through the monitored device 2300x, and from the transmission 2922cmd to the transmission 3933cmd1, is an example of a causal relationship implemented as part of the logic 2345x within the monitored device 2300x for controlling the process 3003x. Stated differently, the logic 2345x implemented within the monitored device 2300x may include logic to cause such relaying of an operational command of this type through the monitored device 2300x, and onward to the external system 3003x.

In response to receiving the transmission 3933cmd1, the effecting device 3800 may act on the operational command therein to do the commanded action (e.g., turning on a heating device to heat a tank). The effecting device 3800 may output, onto the links 3999x and back to the monitored device 2300x, a transmission 3933conf1 conveying operational information that confirms that the operational command is being acted upon by doing the commanded action.

In response to receiving the transmission 3933conf1, the monitored device 2300x may relay the operational information confirming that the operational command is being acted on onward in a transmission 2922conf1 to the monitored device 2300a via the network 2999. As depicted, there is again a time delay within the monitored device 2300x between the time of receipt of the transmission 3933conf1 and the time of output of the transmission 2922conf1. Via the UI, the operator may be informed of this received confirmation.

Within the external system 3000x, one or more sensing devices 3200 may output a succession of transmissions indicative of the results, over time, of the commanded action being performed. More specifically, as the tank is being heated, each transmission in a series of transmissions 3933sen1 through 3933senx may convey operational information concerning the increasing temperature of the tank to the monitored device 2300x via the communication link(s) 3999x. The transmission 3933senx may convey operational information indicating that the tank has reached a particular temperature that is associated with a transition to the process state 3033p2.

The amount of time that it takes to heat the tank to the particular temperature may be subject to external inputs that make such an amount of time relatively difficult to predict. More specifically, if the tank is part of an apparatus that is exposed to the elements, then the amount of time required to heat the tank to the particular temperature may be affected by the weather. Thus, the quantity of transmissions within the series of transmissions 3933sen1 to 3933senx may be difficult, if not impossible, to predict, and this may make the timing of when the transmission 3933senx is output onto the link(s) 3999x similarly difficult to predict.

In response to receiving the transmission 3933senx, the monitored device 2300x may output a transmission 3933cmd2 conveying an operational command to the same effecting device 3800 to stop acting on the earlier operational command in the earlier transmission 3933cmd1. Thus, the effecting device 3800 may be commanded to stop heating the tank. Again, there is a time delay within the monitored device 2300x between the time of receipt of the transmission 3933senx and the time of output of the transmission 3933cmd2.

In response to receiving the transmission 3933cmd2, the effecting device 3800 may act on the operational command therein to cease doing the commanded action (e.g., cease heating the tank). The effecting device 3800 may output, onto the link(s) 3999x and back to the monitored device 2300x, a transmission 3933conf2 conveying operational information that confirms that the earlier operational command to heat the tank is now no longer being acted upon.

In response to receiving the transmission 3933conf2, the monitored device 2300x may relay the operational information confirming that the original operational command to heat the tank has ceased to be acted upon onward in a transmission 2922conf2 to the monitored device 2300a via the network 2999. Again, there is a time delay within the monitored device 2300x between the time of receipt of the transmission 3933conf2 and the time of output of the transmission 2922conf2. Via the UI, the operator may be informed of this received confirmation.

Turning to FIG. 3C, during a performance of the process 3003x, a condition may develop that necessitates stopping the process 3003x as a safety measure. By way of example, it may be that a temperature of a device within the external system 3000x exceeds a threshold, as detected by sensing device 3200, and the logic 2345a and 2345x employed by the monitored devices 2300a and 2300x, respectively, may respond by automatically stopping the process 3003x and providing an alert to an operator.

In a manner similar to the timing of manual input in the above example of FIG. 3B, the timing of when such a condition as overheating may occur may be at least extremely difficult, if not impossible, to predict. This, in turn, may make the timing of when a transmission responsive to such an event is output similarly difficult to predict. However, it should again be noted that the timings of at least some of the transmissions relative to each other may be far more easily predicted, as will be explained in greater detail.

During a process state 3033p of the process 3003x, one or more sensing devices 3200 of the external system 3000x may output a series of transmissions 3933sen1 through 3933senx onto the communication link(s) 3999 and to the monitored device 2300x. Each of these transmissions in this series may convey operational information concerning the status of one or more aspects of the process 3003x, which may include a temperature of a device of the external system 3003x.

As depicted, the process 3003x may go awry such that a transition is made from the depicted process state 3033p in which the process 3003x may be proceeding normally, and to an improper state 3033i in which the process 3003x is no longer proceeding normally. For purposes of this example, it may be that the temperature of that same device of the external system 3003x has risen beyond a particular threshold.

In response to receiving the transmission 3933senx, the logic 2345x implemented within the monitored device 2300x for controlling the process 3003x may output two transmissions. One of the two transmissions may be a transmission 2922alert output onto the network 2999 to convey operational information to the monitored device 2300a that includes an alert that a condition such as an excessive temperature level of a device has arisen. Logic 2345a within the monitored device 2300a for controlling the process 3003x may present the alert to an operator via a UI (not specifically shown). The other of the two transmission may be a transmission 3933cmd that is output onto the link(s) 3999x to convey an operational command to an effecting device 3800 within the external system 3000x to perform an action that stops the process 3003x.

As depicted, the output of each of the transmissions 2922alert and 3933cmd occurs with some amount of delay following receipt of the transmission 3933senx. As also depicted, the delay in the output of the transmission 3933cmd may be somewhat longer as a result of a need for the logic 2345x implemented within the monitored device 2300x to determine whether the process 3003x is to be stopped, and if so, what measure(s) to take to cause the process 3003x to be stopped.

In response to receiving the transmission 3933cmd, an effecting device 3800 of the external system 3000x may act on the operational command therein to cause the process 3003x to be stopped. The effecting device 3800 may output, onto the link(s) 3999x and back to the monitored device 2300x, a transmission 3933conf conveying operational information that confirms that the operational command to stop the process 3003x is now being acted upon.

In response to receiving the transmission 3933conf, the monitored device 2300x may relay the operational information confirming that the process 3003x is being stopped onward in a transmission 2922conf to the monitored device 2300a via the network 2999. Again, there is a time delay within the monitored device 2300x between the time of receipt of the transmission 3933conf and the time of output of the transmission 2922conf. Via the UI, the operator may be informed of this received confirmation.

### Gathering Data to Use in Generating Emulations—Gathering Phase

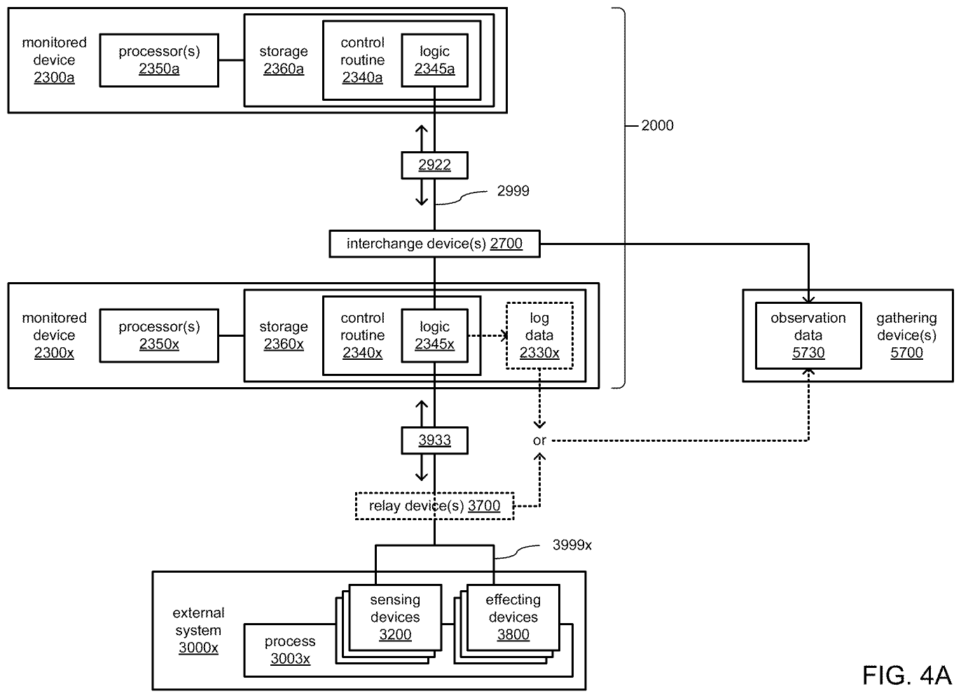

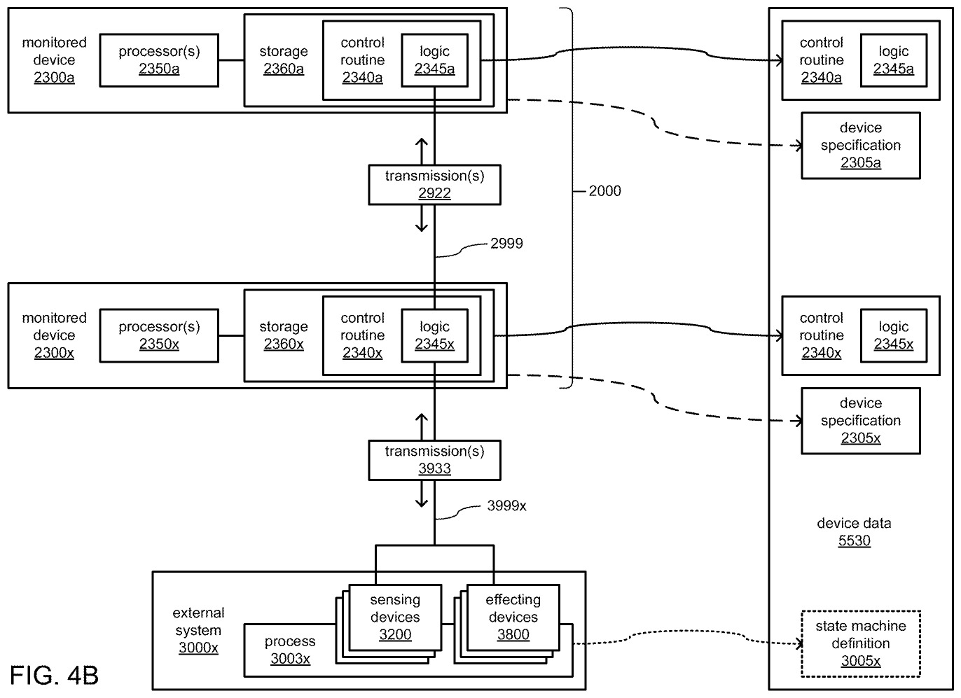

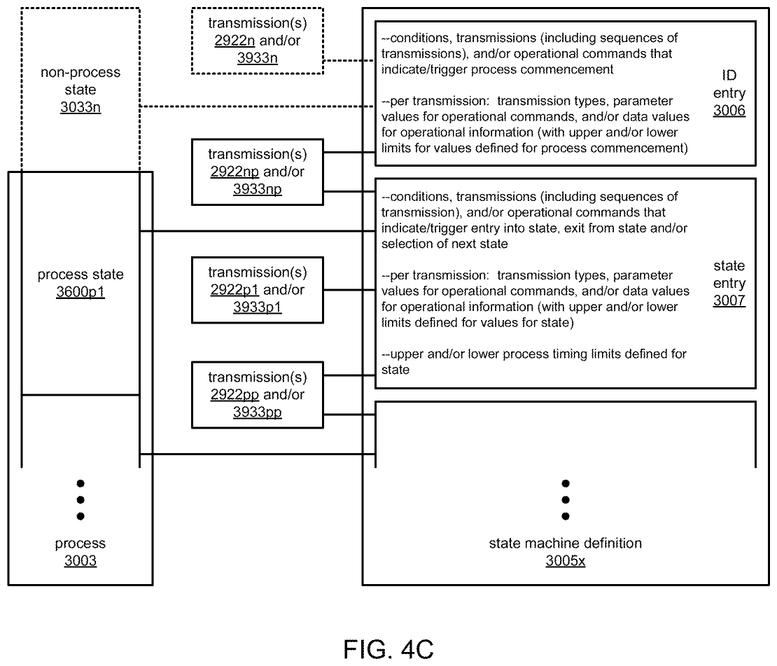

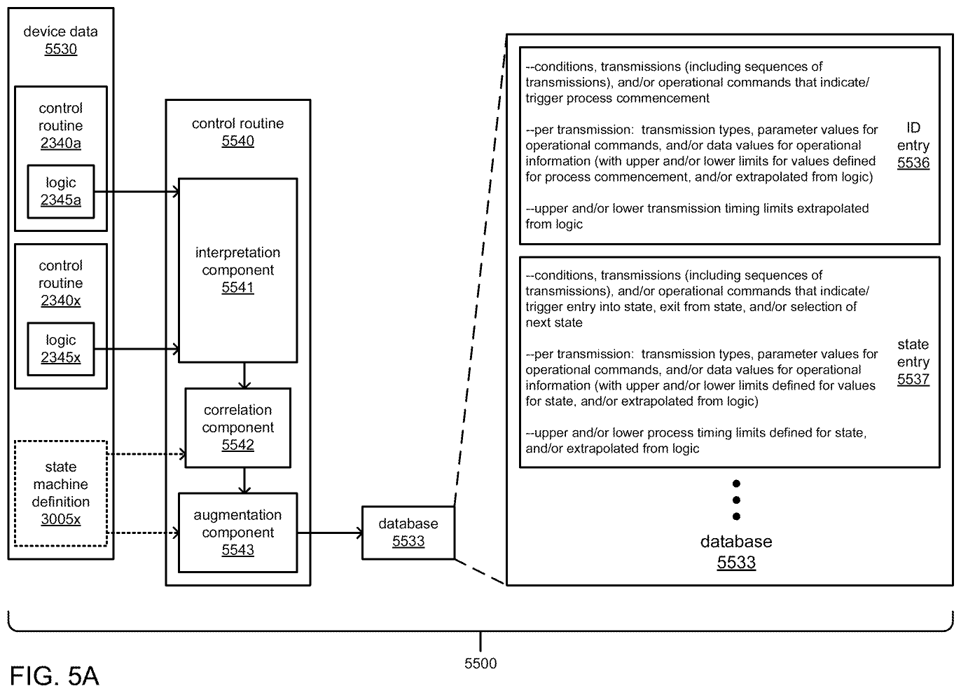

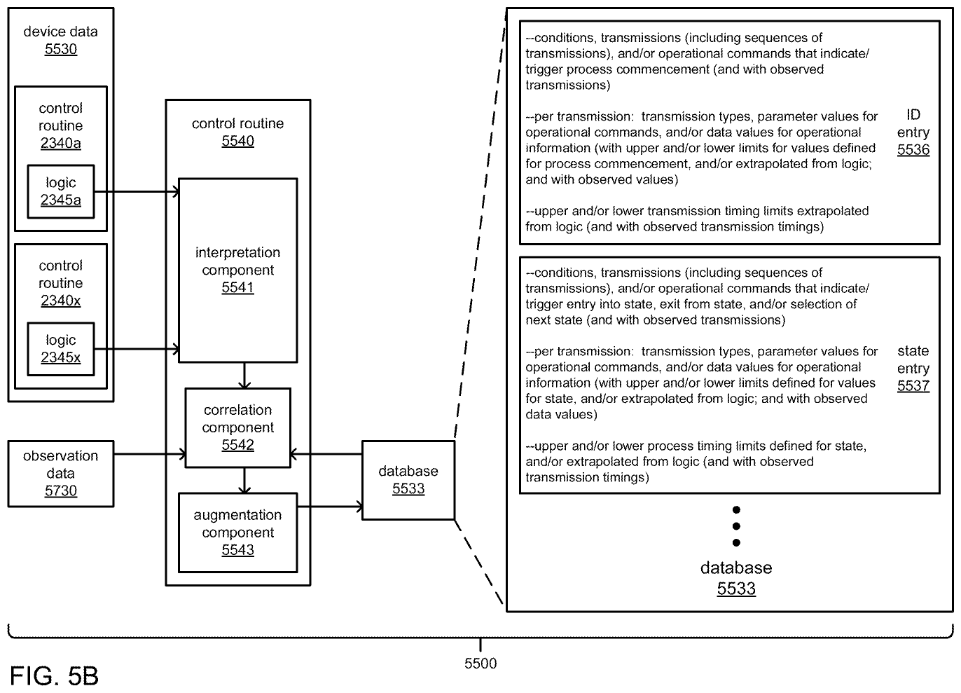

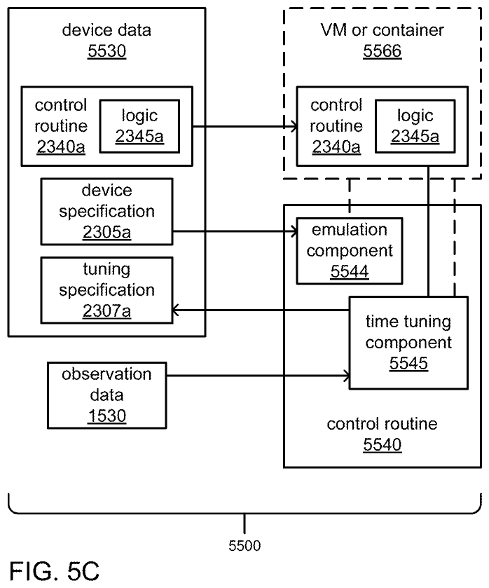

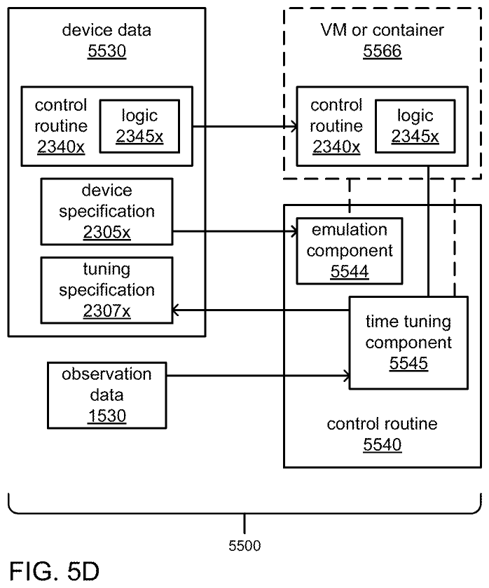

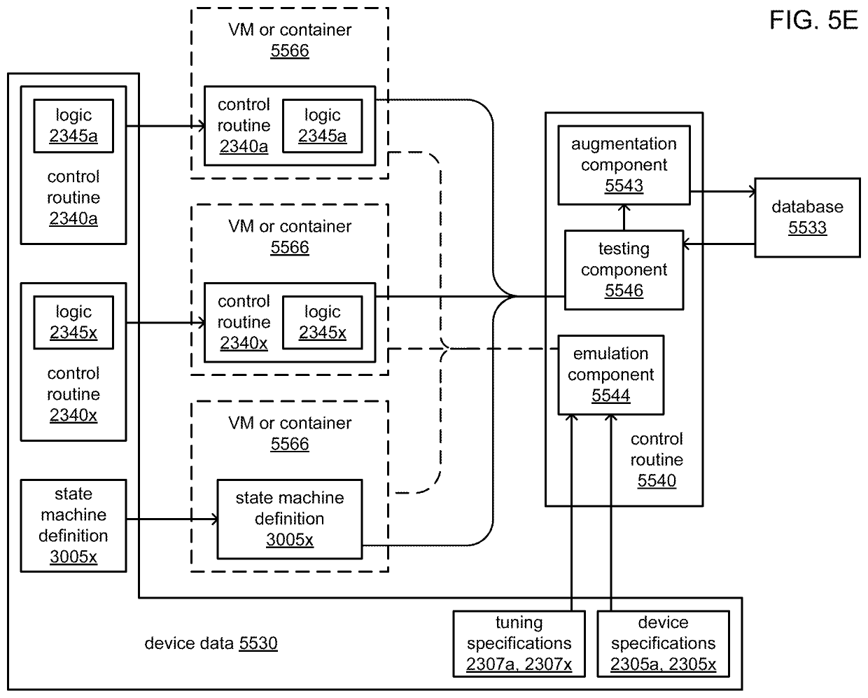

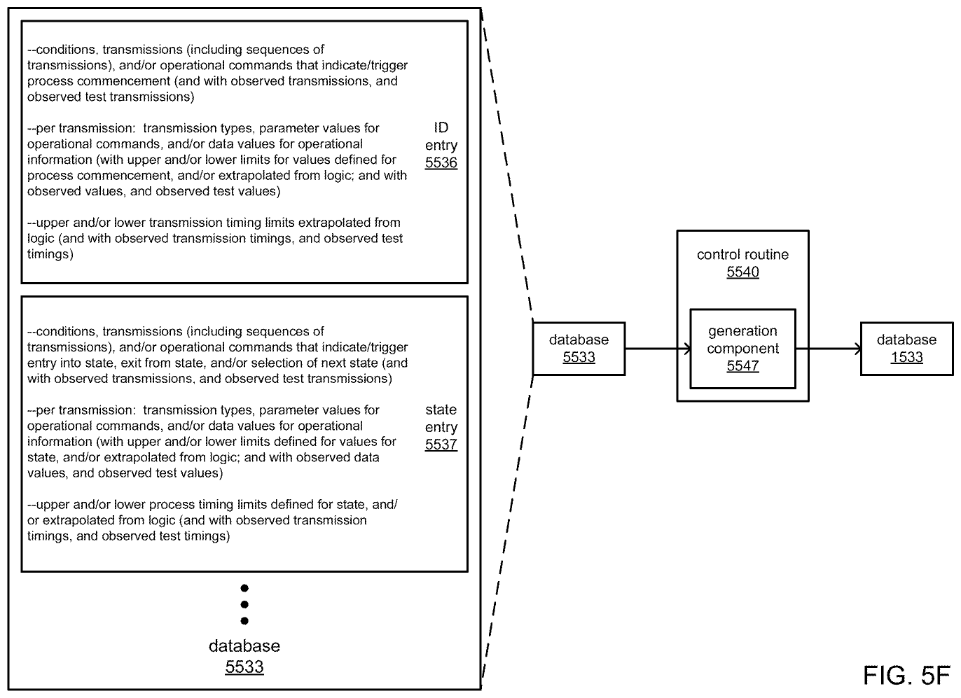

FIGS. 4A, 4B and 4C, taken together, present various aspects of the gathering phase of preparing one or more monitoring devices 1500 for use in monitoring and/or correcting improper network traffic through the network 2999. Again, at a time prior to the pre-training phase (to be discussed in reference to FIGS. 5A-F), one or more gathering devices 5700 may be temporarily coupled to one or more interchange devices 2700, and/or one or more relay devices 3700x of the link(s) 3999x, to generate the observation data 5370 for being provided to one or more emulation devices 5500. Also, the emulation device(s) 5500 may also be provided with the device data 5530 descriptive of aspects of at least monitored device 2300, such as the monitored devices 2300a and 2300x.

Turning to FIG. 4A, as previously discussed, among the items of data needed to generate such emulations of portions of the monitored system 2000, the external system 3000x and/or the process 3003x is the observation data 5730 that documents at least transmissions 2922 among the monitored devices 2300a and 2300x through the network 2999 that are associated with controlling the process 3003x performed within the external system 3000x. It may be deemed preferable that such documented transmissions 2922 include whole sets of transmissions 2922 associated with controlling multiple complete performances the process 3003x. In this way, variations in transmission timing, parameters in transmissions of operational commands, and/or data values in transmissions of operational information that may be deemed to be normal variations may be taken into account in the emulations that are generated. In turn, this may enable the monitoring device(s) 1500 to be prepared to distinguish such normal variations from anomalous variations that are at least more likely to be associated with a malfunction or a cyber attack.

As also previously discussed, it may also be deemed desirable to, if possible, cause the observation data 5730 to similarly document whole sets of corresponding transmissions 3933 that are also associated with the same multiple complete performances of the process 3003x. The inclusion of information concerning the content and timing of the transmissions 3933 may enable the emulation of the progression of a process (e.g., the process 3003x) through its process states to be more accurate.

Again, considerable importance is usually placed on not taking action that may impair the functionality of the one or more links 3999 that couple an external system 3000 to one of the monitored devices 2300. This arises from the fact that the link(s) 3999 often directly couple the sensing devices 3200 and effecting devices 3800 that most directly effect changes in process state, including changes to a pre-selected non-process state in response to an unexpected condition that may damage equipment and/or create a hazard. Thus, attaching devices to the link(s) 3999x as part of capturing and documenting the transmissions 3933 that pass therethrough may be deemed to present an unacceptable risk. As a result, at least where such components as the relay device(s) 3700x are not available and/or not able to be coupled to, it may be deemed more desirable to obtain such information concerning such transmissions 3933 from log data that may be generated and maintained by the monitored device(s) 2300 that are directly involved in such communications (e.g., the depicted log data 2330x of the monitored device 2300x).

Turning to FIG. 4B, as previously discussed, each of the control routines 2340a and 2340x of the monitored devices 2300a and 2300x may implement logic 2345a and 2345x, respectively, that are each part of the logic employed to control performances of the process 3003x. Thus, the device data 5530 may be generated to include copies of both of the control routines 2340a and 2340x to be executed within execution environments generated as part of generating emulations of the monitored devices 2300a and 2300x, respectively.

As also depicted, the device data 5530 may also include device specifications 2305a and 2305x that may each indicative of various characteristics of the hardware and/or software of a corresponding one of the monitored devices 2300a and 2300x. Such characteristics may include, and are not limited to, the type and/or revision level of the processor(s); the type and quantity of volatile and/or non-volatile storage; the type and revision of operating system and/or driver software executed; the type and revision of other software executed; the type and/or revision of network interface(s); etc. The provision of such information may enable a more accurate emulation of each of the monitored devices 2300a and 2300x by enabling more accurate emulations of components thereof.

In some embodiments, the device data 5530 may additionally include a state machine definition 3005x that is descriptive of various aspects of the process states of the process 3003x. It should noted that embodiments are possible in which the device data 5530 is not available, and thus, not included in the device data 5530. This situation may arise as a result of security and/or trade secret concerns, where information concerning details of process 3005x is deemed to be too sensitive to make available. Alternatively or additionally, it may be that a description of the process 3005x as a state machine has never been generated such that it simply does not exist. Thus, in such embodiments in which the state machine definition 3005x is not available for whatever reason, the state machine definition 3005x may be derived from other information contained within the device data 5530 and/or from within the observation data 5730 as part of the pre-training phase of preparing the monitoring device(s) 1500 for use.

Turning to FIG. 4C, in embodiments in which the state machine definition 3005x is provided, the state machine definition 3005x may include a separate state entry 3007 for each process state, and/or may include an identifier (ID) entry 3006 descriptive of various aspects of the manner in which a performance of the process 3003x is caused to begin.

Turning to the depicted ID entry 3006, various conditions and/or events that cause and/or indicate the commencement of the process 3005x may be specified. By way of example, such a specification may specify one or more particular transmissions 2922 through the network 2999 and/or one or more particular transmissions 3933 through the link(s) 3999x that may trigger and/or indicate commencement of the process 3005x. Further, for each transmission, the transmission type (e.g., conveying an operational command or conveying operational information), parameter values for operational commands, data values for operational information may also be specified. Still further, where multiple values are possible for a parameter value or for a data value, a group of discrete values and/or a range of values may be specified in any of a variety of ways (e.g., a maximum value or upper limit, a minimum value or lower limit, a median value, a mean value, an average value, a list of discrete values, a model/formula for deriving values, a probability distribution, etc.).

In some embodiments in which upper and/or lower limits on a value are specified, such upper and/or lower limits may be selected to include values that are associated with various error conditions that have been planned for such that the state machine of the process 3003x and/or the logic 2345a and/or 2345x have been designed to include measures to address those conditions. Indeed, in some embodiments, there may be ranges of values and/or sets of discrete values specified for parameter values and/or data values that are associated with a performance of the process 3003x without error conditions, and other ranges of values and/or sets of discrete values specified for parameter values and/or data values that are associated with a performance of the process 3003x in which one or more anticipated error conditions occur.

Turning to the depicted example state entry 3007, for each state entry 3007, various conditions and/or events that cause and/or indicate entry into the corresponding state, that cause and/or indicate exit from the corresponding state, and/or that cause and/or indicate the selection of the next state may be specified. By way of example, such a specification may specify one or more particular transmissions 2922 through the network 2999 and/or one or more particular transmissions 3933 through the link(s) 3999x that may trigger and/or indicate such entry into and/or exit from the corresponding state, and/or that may cause and/or indicate the selection of the next state. Further, for each transmission, the transmission type, parameter values for operational commands, data values for operational information may also be specified. Again, where multiple values are possible for a parameter value or for a data value, a group of discrete values and/or a range of values may be specified in any of a variety of ways (e.g., a maximum value or upper limit, a minimum value or lower limit, a median value, a mean value, an average value, a list of discrete values, a model/formula for deriving values, a probability distribution, etc.). Further, each state entry 3007 may also specify upper and/or lower timing limits for the performance of different actions during the corresponding state.

### Using Gathered Data to Define Aspects of Emulations—Pre-Training Phase

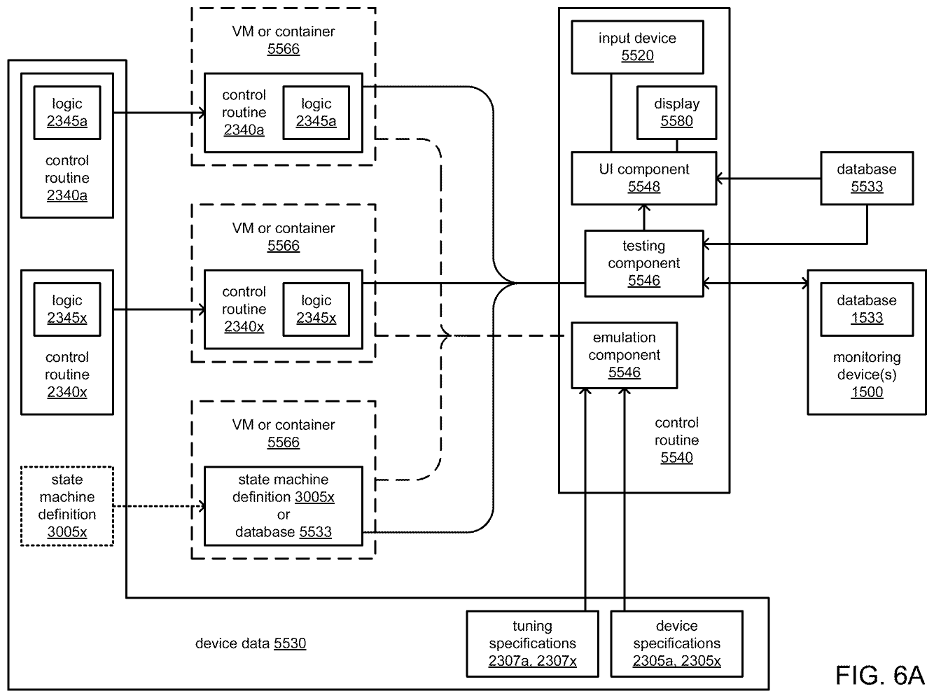

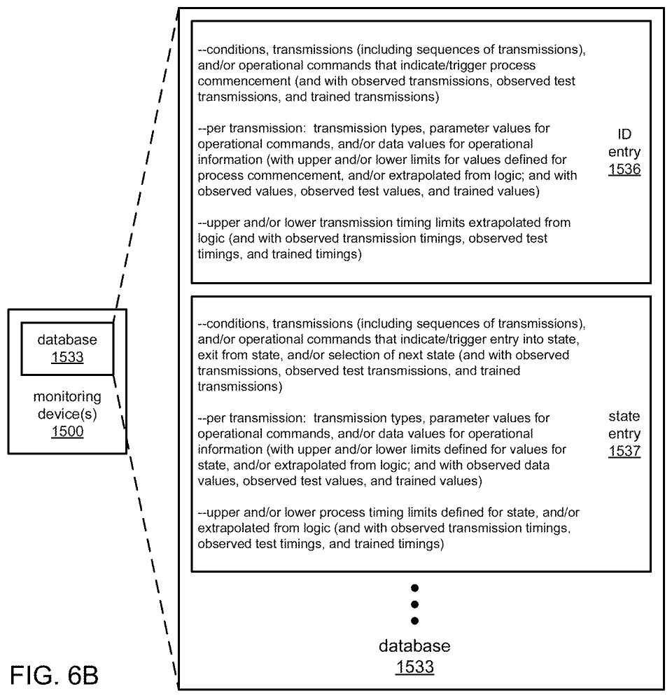

FIGS. 5A, 5B, 5C, 5D, 5E and 5F, taken together, present various aspects of the pre-training phase of preparing one or more monitoring devices for use in monitoring and/or correcting improper network traffic through the network 2999. Again, at a time following the gathering phase (just discussed in reference to FIGS. 4A-C), and prior to the training phase (to be discussed in reference to FIGS. 6A-B), one or more emulation devices 5500 may use the observation data 5730 together with the device data 5530 to prepare for generating emulations of portions of the monitored system 2000, the external system 3000x and/or the process 3003x. In so doing, preparations are made for using such emulations together to prepare the one or more monitoring devices 1500.

Turning to FIG. 5A, the control routine 5540 executed by processor(s) 5550 of at least one of the emulation devices 5500 may include an interpretation component 5541 to parse and/or analyze logic employed by monitored devices 2300, a correlation component 5542 to correlate portions of such logic and/or of state machine definitions, and an augmentation component 5543 to begin the generation of the database 5533.

As previously discussed, each of the monitored devices 2300 (including the monitored devices 2300a and 2300x) may be a computing device. Thus, it is envisioned that each monitored device 2300 may incorporate any of a variety of types of processor, storage components, peripheral components, etc. As a result, any of a variety of processor instruction sets, peripheral and/or storage addressing architectures, etc. may be used. The device specifications of 2305a and 2305x within the device data 5530 may specify such aspects of each monitored device 2300a and 2300x thereby enabling the selection of a version of the interpretation component 5541 that may incorporate a matching instruction de-compiler, analyzer and/or interpreter to enable parsing of the logic 2345a and 2345x, respectively, as the interpretation component 5541 is executed by the processor(s) 5550 of at least one of the emulation devices 5500.

As also previously discussed, in some embodiments, a state machine definition 3005 (such as the state machine definition 3005x) that describes the set of process states 3033 of the process 3003 that is being controlled may be provided, while in other embodiments, such a state machine definition 3005 may not be provided.

In embodiments in which the state machine definition 3005x is provided, then execution of the correlation component 5542 may cause the processor(s) 5550 to identify the process states 3033 of the process 3003x that correspond to each of various portions of the logic 2345a and 2345x. With such correlations identified, execution of the augmentation component 5543 may cause the processor(s) 5550 to generate the database 5533 to include the contents of the state machine definition 3005x, with augmentations from the correlated portions of logic.

However, in embodiments in which the state machine definition 3005x is not provided, then execution of the correlation component 5542 may cause the processor(s) to identify portions of the logic 2345a to portions of the 2345x. The processor(s) 5550 may then be caused to derive the set of process states 3033 of the process 3003x from the now correlated combination of the logic 2345a and 2345x. With such correlations identified, and with the set of process states 3033 derived, execution of the augmentation component 5543 may cause the processor(s) 5550 to generate the database 5533.

Thus, the database 5533 may be generated to have an internal structure somewhat similar to that of the state machine definition 3005x that may or may not have been provided (refer back to FIG. 4C). More specifically, the database 5533 may have an ID entry 5536 and multiple state entries 5537 that would correspond in organization an content to the ID entry 3006 and the multiple state entries 3007, respectively, within the state machine definition 3005x (if provided).

However, in comparison to the ID entry 3006, the ID entry 5536 of the database 5533 may include additional information extrapolated from correlations to portions of the logic 2345a and 2345x associated with causing the commencement of performance of the process 3003x. Such additional information may include, and not be limited to, upper and/or lower limits of parameter values and/or data values, and/or upper and/or lower limits for the timings of when each transmission is to occur. Such information may be descriptive of both transmissions 2922 that pass through the network 2999 and transmissions 3933 that pass through the network 3999.

Also, in comparison to the state entries 3007, each state entry 5537 of the database 5533 may include additional information extrapolated from correlations to portions of the logic 2345a and 2345x associated with the corresponding process state 3033 of the process 3003x. Again, such additional information may include, and not be limited to, upper and/or lower limits of parameter values and/or data values, and/or upper and/or lower limits for the timings of when each transmission is to occur. Also again, such information may be descriptive of both transmissions 2922 that pass through the network 2999 and transmissions 3933 that pass through the network 3999.

Where such extrapolations from the logic 2345a and 2345x are concerned, it should be noted that, while the state machine definition 3005x may have specified various constraints for timings, parameter values and/or data values based on various requirements for each state of the process 3003x, the logic 2345a and/or 2345x may impose additional constraints that are also required to be satisfied. As a result, the specifications of timings, parameter values and/or data values within the ID entry 5536 and the state entries 5537 may become more constrained than corresponding specifications based on the state machine definition 3005x, alone.

Turning to FIG. 5B, the correlation component 5542 may again be executed to cause the processor(s) 5550 to correlate each of the observed transmissions 2922/3933 indicated in the observation data 5730 to one of the process states described in the database 5533 for the process 3003x. The augmentation component 5543 may also again be executed to cause augmentation of the ID entry 5536 and each of the state entries 5537 with indications of timings, operational commands, parameter values and/or data values that were actually observed for each of the observed transmissions 2922/3933.

As a result, the entries 5536 and 5537 of the database 5533 are caused to include indications of real world observations for such information for each transmission 2922/3933 associated with each state, in addition to the ranges and/or sets of possible timings, commands and/or values that are specified by the state machine definition 3005x, and/or that are extrapolated from the logic 2345a and 2354x.

In some embodiments, a statistical analysis may be performed based on the observed timings of the observed transmissions 2922/3933 that takes into account whatever variation in timings may be observed across multiple performances of the process 3003x. From such an analysis for each transmission, a range of timing for when the transmission is expected to occur may be specified in the database 5533, or a probability distribution of timing for when the transmission is expected to occur may be specified.

Turning to FIG. 5C, the control routine 5540 may also include an emulation component 5544 and a time tuning component 5545. Execution of the emulation component 5544 may cause the processor(s) 5550 of one of the emulation devices 5500 to instantiate an execution environment in which the control routine 2340a of the monitored device 2300a may be executed. As depicted, such an execution environment may be a virtual machine (VM) or a container 5566. Regardless of the exact nature and/or characteristics of the execution environment that is provided, further execution of the emulation component 5544 may cause the processor(s) 5550 to retrieve indications of characteristics of the monitored device 2300a from the device specification 2305a to guide aspects of the execution environment (e.g., the VM or container 5566) that is provided, thereby providing an execution environment for the execution of the control routine 2340a that relatively closely mimics various aspects of the execution environment normally provided to the control routine 2340a within the monitored device 2300a.

With such an execution environment provided, execution of the time tuning component 5545 by the processor(s) 5550 may cause the retrieval of indications of amounts of time between transmissions 2922 and/or 3933 that are causally linked by portions of the logic 2345a of the control routine 2340a. Referring briefly back to FIGS. 3B-C, as was discussed in reference to the logic 2345x, there may be portions of that logic that are triggered to output a transmission 2922/3933 in response to the receipt of a transmission 2922/3933, and such a response may take place with an amount of time delay. As was also discussed (but not specifically depicted), similar responses with time delays may also be exhibited by the logic 2345a. As has been discussed, the observation data 5730 includes timing information for each observed transmission 2922 and 3933 that documents the amount of time that elapsed for each such delay.

Returning to FIG. 5C, in executing the time tuning component 5545, the clock speed, number of processing cycles per second allocated to the VM or container 5566, and/or another parameter that exerts influence over the speed of execution of the control routine 2340a therein may be manipulated to cause the time delays exhibited by the logic 2345a therein to at least relatively closely match those documented in the observation data 5730. In this way, a time tuning setting may be identified to cause the timing behavior of the logic 2345a within the VM or container 5566 to match the timing behavior of the logic 2345a within the monitored device 2300a. An indication of the time tuning setting that begets such timing behavior may then be added to device data 5530 as the depicted tuning specification 2307a.

Turning to FIG. 5D, a similar use of information in the device specification 2305x, emulation, and time tuning may be performed to similarly identify a time tuning setting for the logic 2345x, and an indication thereof may be stored within the device data 5530 as the tuning specification 2307x.

With such time tuning settings having been identified for use in emulating the monitored devices 2300a and 2300x, the monitored devices 2300a and 2300x may now be emulated with relatively accurate timings.

Turning to FIGS. 5E-F, the control routine 5540 may additionally include a testing component 5546 to perform various tests of an emulated combination of the monitored devices 2300a and 2300x interacting with an emulation of the process 3003x based on the state machine definition 3005x. In executing the emulation component 5544, the processor(s) 5550 of at least one of the emulation devices 5500 may be caused to instantiate VMs or containers 5566 in which the execution environments of the monitored devices 2300a and 2300x may be emulated to enable the control routines 2340a and 2340x, respectively, to be executed therein. Additionally, another VM or container 5566 may be instantiated in which the state machine of the process 3003x may be implemented. In further executing the emulation component 5544, communications among these VMs or containers 5566 may be enabled to allow transmissions 2922 and 3933 thereamong in a manner that mimics the communications enabled by the network 2999 and the link(s) 3999x.

In executing the testing component 5546, the processor(s) 5550 may be caused to parse the database 5533 for lower and/or upper limits for timings for events that trigger the output of transmissions 2922 and/or 3933. Such events may include simulated operator inputs via a UI to the logic 2345a, and/or simulated measurements taken by simulated sensing devices 3200 for the process 3003x. Experiments may then be performed in which each of such simulated inputs are performed, each timed to meet its corresponding lower and upper limits for timing of occurrence. In this way, edge and/or corner cases based on corresponding upper and/or lower limits of transmissions 2922 and/or 3933 that are triggered by these inputs may be tested.

Further execution of the testing component 5546 may then cause the resulting test timings of those transmissions 2922 and/or 3933 to be documented, and execution of the augmentation component 5543 may then cause the indications of timings for transmissions already present in the database 5533 to be augmented with these observed test timings. In this way, the upper and/or lower limits for timings with which transmissions 2922 and/or 3933 might actually occur in edge and/or corner cases may be added to the database 5533, alongside the timings actually observed during normal operation of the monitored system 2000 together with the process 3003x.

In some embodiments, the resulting combination of transmission timings that are extrapolated from the combination of the logic 2345a and 2345x; that are observed to have actually taken place during normal operation; and that are derived from such experimentation with edge and/or corner cases as just described may be combined to generate indications in the database 5533. As a result, for each transmission, the database 5533 may include indications of what timings are possible in theory, versus what timings are possible in unlikely extreme timing conditions, versus what timings have actually been observed to occur. In some of such embodiments, each such indication of timings for a transmission may take the form of a probability distribution indicative of relative likelihoods of theoretically possible timings, vs. unlikely timings under extreme conditions, vs. timings that have actually been observed to occur.

Regardless of the exact way in which such indications of timings are represented in the database 5533, such extensive timing information for at least transmissions 2922 through the network 2999 may enable better the distinguishing between proper and improper transmissions 2922 through the network 2999, as well as more certain identification of when a span of time has elapsed without an expected transmission 2922 having occurred. Alternatively or additionally, such extensive timing information for transmissions 2922 and/or 3933 may enable the provision of emulations guided by such timing information for diagnostics, testing and/or training purposes.

As depicted in FIG. 5F, with the database 5533 having been generated as described above, execution of a generation component 5547 of the control routine 5540 may cause processor(s) 5550 of an emulation device 5500 to generate the database 1533 therefrom. It may be that the database 1533 is somewhat reduced in content from the database 5533. By way of example, information concerning transmissions 3933 through the link(s) 3999x may not be included in the database 1533 as the communications traffic through the link(s) 3999x may not normally be monitored by the monitoring device(s) 1500.

### Using the Emulations—Training Phase

FIGS. 6A and 6B, taken together, present various aspects of the training phase of preparing one or more monitoring devices for use in monitoring and/or correcting improper network traffic through the network 2999. Again, at a time following the pre-training phase (just discussed in reference to FIGS. 5A-F), and prior to such actual use of the monitoring device(s) 1500 in monitoring and/or correcting improper network traffic through the network 2999, may be temporarily coupled to the emulation device(s) 5500 to be trained and/or tested using the emulated network traffic among the emulations of various monitored devices 2300 (e.g., emulations of the monitored devices 2300a and 2300x).

Turning to FIG. 6A, as depicted, the database 5533 may be used as an input to a UI component 5548 of the control routine 5540 to guide the presentation of options for manual testing to an operator through a user interface that employs an input device 5520 and/or a display 5580 of an emulation device 5500. More precisely, the database 5533 may be used to provide an operator with options for defining one or more experiments that are based on the indications within the database 5533 of what parameter values, data values, timings, etc. have been determined to be possible as a result of the aforedescribed interpretation, extrapolation and experimentation operations.

Turning to FIG. 6B, as part of such testing, the monitoring device(s) 1500 may be placed in a training mode to enable the learning of new possible transmissions 2922 that may occur as part of proper network traffic on the network 2999, to enable the learning of new possible parameter values and/or data values for the contents of transmissions 2922 that may occur through the network 2999, and/or to enable the learning of new timings for those transmissions 2922. As a result, such new information concerning transmissions 2922 that may occur through the network 2999 may be added to the specifications of transmissions, transmission contents and/or transmission timings already stored within the database 1533 within the monitoring devices 1500.

Among the uses that may be made of the set of emulations provided by the emulation device(s) 5500, other uses are possible including but not limited to (a) Archive Storage: a facility's support team may wish to store its network traffic captures for historical and future comparison purposes; (b) Equipment Function Validation: checking on and/or verifying the functioning of Operational Technology (OT) network equipment, Industrial Control Systems (ICS) processes, and field equipment; (c) Diagnostic Debug: debugging the functioning of OT (operational technology) network equipment, ICS processes, and field equipment to find and solve otherwise difficult to detect and/or solve problems; (d) Datamining (AI or otherwise): uncovering minute as well as major patterns and trends in production equipment command-and-control and usage that would otherwise not be readily easy to uncover; (e) Cyber Security Malware & Hacker analysis: isolating and analyzing rogue, harmful or malicious OT network traffic sent by or otherwise altered by nefarious attackers and/or their hardware/software equipment; (f) Monitoring & Reporting: there are entire classes of important and sophisticated facility reports that virtually cannot be produced any other way; (g) Cost Performance Analysis & Improvement: conducting live, in-depth technical, production, and/or performance research on an entire ICS facility full of equipment produced by different vendor makes and models of all at the same time; (h) Product Development & Improvement: ICS vendors studying the function and performance of their respective ICS hardware and software products, each for their own respective product improvement purposes and new product development purposes.

While this disclosure has been described in connection with specific embodiments, it is evident that numerous alternatives, modifications, and variations will be apparent to those skilled in the art within the spirit and scope of the above disclosure.

We claim:

1. An emulation system comprising a processor configured to perform operations comprising:
correlate a first set of transmissions through a network of a monitored system to a first set of responses of a first control routine logic executed within a first monitored device of the monitored system, wherein the monitored system controls an industrial process performed within an external system coupled to the monitored system;
adjust a first parameter influencing an execution speed of the first control routine logic within a first emulation of the first monitored device to cause a response timing of the first set of responses to match a timing between two transmissions of the first set of transmissions; and
use at least the first emulation to prepare a monitoring device to monitor the network to detect improper network activity affecting the industrial process while the monitored system controls the industrial process.

2. The emulation system of claim 1, wherein the response of the first set of responses comprises the first control routine logic responding to receiving, at the first monitored device and from the network, a first transmission of the two transmissions by outputting, from the first monitored device and onto the network, a second transmission of the two transmissions.

3. The emulation system of claim 1, wherein:
the first set of transmissions between at least the first monitored device and a second monitored device of the monitored system pass through the network; and
the processor is further configured to perform operations comprising:
correlate the first set of transmissions to a second set of responses of a second control routine logic executed within the second monitored device;
adjust a second parameter influencing an execution speed of the second control routine logic within a second emulation of the second monitored device to cause another response timing of the first set of responses to match a timing between two other transmissions of the first set of transmissions; and
use the second emulation in conjunction with the first emulation to prepare the monitoring device to monitor the network to detect improper network activity affecting the industrial process while the monitored system controls the industrial process.

4. The emulation system of claim 3, wherein, at a time prior to the preparation of the monitoring device, the monitoring device is coupled to the network to capture the first set of transmissions between the first monitored device and the second monitored device.

5. The emulation system of claim 3, wherein, at a time prior to the preparation of the monitoring device, a separate gathering device is coupled to the network to capture the first set of transmissions between the first monitored device and the second monitored device.

6. The emulation system of claim 3, wherein, at a time prior to the preparation of the monitoring device, either the first monitored device or an interchange device of the network is configured by execution of instructions of an executable routine to capture the first set of transmissions passing through the network between the first monitored device and the second monitored device.

7. The emulation system of claim 1, wherein:
the first monitored device is coupled to the external system via a communications link; and
the processor is further configured to perform operations comprising:
correlate a second set of transmissions through the communications link to the first set of responses of the first control routine logic executed within the first monitored device; and
adjust the first parameter influencing the execution speed of the first control routine logic within the first emulation to additionally cause another response timing of the first set of responses to match a timing between two other transmissions of at least one of the first set of transmissions and the second set of transmissions.

8. The emulation system of claim 7, wherein the other response of the first set of responses comprises the first control routine logic responding to receiving, at the first monitored device and from one of the network and the communications link, a first transmission of the other two transmissions by outputting, from the first monitored device and onto another of the network and the communications link, a second transmission of the two transmissions.

9. The emulation system of claim 7, wherein the other response of the first set of responses comprises the first control routine logic responding to receiving, at the first monitored device and from the communications link, a first transmission of the other two transmissions by outputting, from the first monitored device and onto the communications link, a second transmission of the two transmissions.

10. The emulation system of claim 1, wherein:
the external system comprises at least one of:
a sensing device to measure an aspect of the industrial process within the external system; or
an effecting device to control an aspect of the industrial process within the external system; and
the first set of transmissions comprises at least one of:
a transmission conveying operational information indicative of the measure from the sensing device to the first monitored device; or
a transmission conveying an operational command from the first monitored device to the effecting device.

11. The emulation system of claim 10, wherein:
a performance of the industrial process is describable as a state machine in which the performance progresses, one state at a time, through a set of states; and
the processor is further configured to perform operations comprising:
analyze at least one of a definition of the state machine or the first control routine logic to identify one of:
a timing limit of a transmission of the first set of transmissions;
a parameter limit of a parameter operational command in a transmission; or
a data value limit of operational information in a transmission;
use the identified one of the timing limit, the parameter limit or the data value limit in the first emulation to test the preparation of the monitoring device to detect improper network activity.

12. The emulation system of claim 11, wherein:
the timing limit of the transmission comprises a time at which the transmission is expected to be output onto the network;
the parameter limit of the parameter comprises at least one of an upper limit or a lower limit for a range of values for the parameter; and
the data value limit of the operational information comprises at least one of an upper limit or a lower limit for a range of values for the data value.

13. The emulation system of claim 1, wherein the monitoring device is prepared to respond to an instance of the improper network activity by performing an operation comprising at least one of:
providing an alert of the instance;
logging an indication of the instance;
outputting a transmission onto the network to substitute for an expected transmission that failed to occur on the network; and
outputting a transmission onto the network to countermand or substitute for an improper transmission.

14. A method of preparing a monitoring device to monitor a network comprising:
correlating, by a processor of an emulation system, a first set of transmissions through a network of a monitored system to a first set of responses of a first control routine logic executed within a first monitored device of the monitored system, wherein the monitored system controls an industrial process performed within an external system coupled to the monitored system;
adjusting, by the processor, a first parameter influencing an execution speed of the first control routine logic within a first emulation of the first monitored device to cause a response timing of the first set of responses to match a timing between two transmissions of the first set of transmissions; and
using, by the processor, at least the first emulation to prepare the monitoring device to monitor the network to detect improper network activity affecting the industrial process while the monitored system controls the industrial process.

15. The method of claim 14, wherein the response of the first set of responses comprises the first control routine logic responding to receiving, at the first monitored device and from the network, a first transmission of the two transmissions by outputting, from the first monitored device and onto the network, a second transmission of the two transmissions.

16. The method of claim 14, wherein:
the first set of transmissions between at least the first monitored device and a second monitored device of the monitored system pass through the network; and
the method further comprises:
correlating, by the processor, the first set of transmissions to a second set of responses of a second control routine logic executed within the second monitored device;
adjusting, by the processor, a second parameter influencing an execution speed of the second control routine logic within a second emulation of the second monitored device to cause another response timing of the first set of responses to match a timing between two other transmissions of the first set of transmissions; and
using, by the processor, the second emulation in conjunction with the first emulation to prepare the monitoring device to monitor the network to detect improper network activity affecting the industrial process while the monitored system controls the industrial process.

17. The method of claim 16, wherein, at a time prior to the preparation of the monitoring device, the monitoring device is coupled to the network to capture the first set of transmissions between the first monitored device and the second monitored device.

18. The method of claim 16, wherein, at a time prior to the preparation of the monitoring device, a separate gathering device is coupled to the network to capture the first set of transmissions between the first monitored device and the second monitored device.

19. The method of claim 16, wherein, at a time prior to the preparation of the monitoring device, either the first monitored device or an interchange device of the network is configured by execution of instructions of an executable routine to capture the first set of transmissions passing through the network between the first monitored device and the second monitored device.

20. The method of claim 14, wherein:
the first monitored device is coupled to the external system via a communications link; and
the method further comprises:
correlating, by the processor, a second set of transmissions through the communications link to the first set of responses of the first control routine logic executed within the first monitored device; and
adjusting, by the processor, the first parameter influencing the execution speed of the first control routine logic within the first emulation to additionally cause another response timing of the first set of responses to match a timing between two other transmissions of at least one of the first set of transmissions and the second set of transmissions.

21. The method of claim 20, wherein the other response of the first set of responses comprises the first control routine logic responding to receiving, at the first monitored device and from one of the network and the communications link, a first transmission of the other two transmissions by outputting, from the first monitored device and onto another of the network and the communications link, a second transmission of the two transmissions.

22. The method of claim 20, wherein the other response of the first set of responses comprises the first control routine logic responding to receiving, at the first monitored device and from the communications link, a first transmission of the other two transmissions by outputting, from the first monitored device and onto the communications link, a second transmission of the two transmissions.

23. The method of claim 14, wherein:
the external system comprises at least one of:
a sensing device to measure an aspect of the industrial process within the external system; or
an effecting device to control an aspect of the industrial process within the external system; and
the first set of transmissions comprises at least one of:
a transmission conveying operational information indicative of the measure from the sensing device to the first monitored device; or
a transmission conveying an operational command from the first monitored device to the effecting device.

24. The method of claim 23, wherein:
a performance of the industrial process is describable as a state machine in which the performance progresses, one state at a time, through a set of states; and
the method further comprises:
analyzing, by the processor, at least one of a definition of the state machine or the first control routine logic to identify one of:
a timing limit of a transmission of the first set of transmissions;
a parameter limit of a parameter operational command in a transmission; or
a data value limit of operational information in a transmission;
using, by the processor, the identified one of the timing limit, the parameter limit or the data value limit in the first emulation to test preparation of the monitoring device to detect improper network activity.

25. The method of claim 24, wherein:
the timing limit of the transmission comprises a time at which the transmission is expected to be output onto the network;
the parameter limit of the parameter comprises at least one of an upper limit or a lower limit for a range of values for the parameter; and
the data value limit of the operational information comprises at least one of an upper limit or a lower limit for a range of values for the data value.

26. The method of claim 14, wherein the monitoring device is prepared to respond to an instance of the improper network activity by performing an operation comprising at least one of:
providing an alert of the instance;
logging an indication of the instance;
outputting a transmission onto the network to substitute for an expected transmission that failed to occur on the network; and
outputting a transmission onto the network to countermand or substitute for an improper transmission.
